(19) United States
(12) Patent Application Publication
(10) Pub. No.: US 2023/0244970 A1
(43) Pub. Date: Aug. 3, 2023

(54) COLLECTIVE CONFIGURATION OF SYSTEMS USING TRUSTWORTHY GRAPH ARTIFICIAL INTELLIGENCE WITH UNCERTAINTY PROPAGATION

(71) Applicant: NEC Laboratories Europe GmbH, Heidelberg (DE)

(72) Inventor: Zhao Xu, Heidelberg (DE)

(21) Appl. No.: 17/740,454

(22) Filed: May 10, 2022

Related U.S. Application Data
(60) Provisional application No. 63/304,048, filed on Jan. 28, 2022.

(51) Int. Cl. G06N 7/00; G06N 3/08; G06K 9/62

(52) U.S. Cl. CPC G06N 7/005; G06N 3/084; G06K 9/6296

(57) ABSTRACT

A method provides a trustworthy artificial intelligence graph-based solution for configuring a plurality of systems in a network. The method includes generating a graph in which each node in the graph represents one of the plurality of systems, wherein links are created between the nodes in the graph, and passing messages along the links. Each node passes a message and a level of uncertainty in the message to neighboring nodes of each node, and receives subsequent messages and subsequent levels of uncertainty in the subsequent messages from the neighboring nodes. The method also includes updating, by each node based on the subsequent messages and the subsequent levels of uncertainty in the subsequent messages received from the neighboring nodes, the respective message and the respective level of uncertainty in the respective message, and predicting configuration values for the systems based on the updated messages and the updated levels of uncertainty.

### CROSS-REFERENCE TO RELATED APPLICATION

Priority is claimed to U.S. Provisional Patent Application No. 63/304,048, filed on Jan. 28, 2022, the entire disclosure of which is hereby incorporated by reference herein.

### FIELD

The present invention relates to a method, system and computer-readable medium for trustworthy graph Artificial Intelligence (AI) solutions to collectively configure a plurality of virtualized systems.

### BACKGROUND

With the evolution of internet-of-things (IoT) and 5G networks, a massive number of softwareized systems work together as a whole. It can be tricky to configure the large set of systems with optimal settings, since each single system does not work separately, but often relies on each other. Setting configurations of a single system have to consider the status and properties of its neighbor systems.

In general, in the current state of the art, the operators set the configurations of systems manually or use the default values. For example, to deploy virtualized distributed units on edge (e.g. Kubernetes based platforms), the operators may have to manually specify requests and limits of central processing unit (CPU)/storage usage for each vDU. The parameter request relates to how many resources are needed on average, while the parameter limit means the maximum amount of resources for the vDU. When the number of vDUs is large, the deployment becomes tricky.

### SUMMARY

In an embodiment, the present disclosure provides a method for providing a trustworthy artificial intelligence (AI) graph-based solution for configuring a plurality of systems in a network. The method includes generating a graph in which each node in the graph represents one of the plurality of systems, wherein links are created between the nodes in the graph, and passing messages along the links. Each node passes a message and a level of uncertainty in the message to neighboring nodes of each node, and receives subsequent messages and subsequent levels of uncertainty in the subsequent messages back from the neighboring nodes. The method also includes updating, by each node based on the subsequent messages and the subsequent levels of uncertainty in the subsequent messages that were received from the neighboring nodes, the respective message and the respective level of uncertainty in the respective message, and predicting configuration values for the systems based on the updated messages and the updated levels of uncertainty.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates exemplary communications between a system and its neighbor systems;

FIG. 2 illustrates an exemplary deployment of open radio access network (ORAN) virtualized distributed units (vDUs), with created vDUs graph as solid lines;

FIGS. 3a and 3b illustrate the relations between a learned uncertainty and a graph topology of an exemplary embodiment of the present disclosure;

FIG. 4a illustrates a predictive probability for a cora dataset;

FIG. 4b illustrates a predictive probability for a citeseer dataset;

FIG. 5 illustrates message passing with a graph convolutional network (GCN);

FIG. 6 illustrates an uncertainty propagation from neighbors to a node in a graph;

FIGS. 7a-d illustrate distributions of probabilities for in-distribution (InDist) test nodes vs. out of distribution (OOD) nodes;

FIGS. 8a-d illustrate an influence of a node degree on a learner uncertainty;

FIGS. 9a-b illustrate an influence of an averaged shortest path length from a test node to training nodes on the learned uncertainty;

FIG. 10 illustrates an exemplary method for configuring a number of systems;

FIG. 11 illustrates an exemplary matrix of covariance among the system i and its neighbors that considers full correlations among the neighbors;

FIG. 12 illustrates another exemplary block matrix of the covariance matrix between the node i and its neighbor N (i) in a sparse case where the neighbors are not correlated with each other;

FIG. 13 summarizes predictive performance of an exemplary embodiment in the normal setting; and

FIG. 14 summarizes predictive performance of an exemplary embodiment for the InDist nodes in the OOD setting.

### DETAILED DESCRIPTION

Embodiments of the present disclosure provide a system, method, and computer-readable medium for a trustworthy graph AI solution to collectively configure a number of virtualized systems. Exemplary embodiments can automatically generate optimal configurations for deployment of a massive number of systems. Exemplary embodiments can also provide not only optimal configuration settings, but also a confidence level or estimated uncertainty of the solution. The virtualized systems can make use of the learned results given a predefined confidence level to further improve their performance and functionality. For example, by optimizing the configuration settings of correlated systems, the systems collectively improve their technical performance (e.g., improving computational speed/performance, allowing to conserve computational resources, increasing accuracy of system outputs, and/or reducing hardware requirements). Moreover, the solutions are trustworthy and the provided confidence levels allow for further selection of different solutions while taking the uncertainty of these solutions into account, thereby also enhancing flexibility.

Exemplary embodiments of the present disclosure provide a trustworthy graph AI solution to collectively configure a massive number of virtualized systems. The embodiments provide the end users with not only optimal system configurations, but also confidence of the AI-based estimation.

Accordingly, the AI-driven management and orchestration provides users with knowledge of when to trust its results, which, however, is not supported by existing techniques.

Modern neural networks (NNs) have widely been applied in a variety of learning tasks and data modalities due to brilliant performance. However the concern with predictive uncertainty of NNs has recently been raised, especially in the domains, e.g. healthcare, autonomous driving and robotics, where the cost and damage caused by overconfident/underconfident predictions are highly sensitive. The literature has explored diverse techniques to solve the problem, including e.g. embedding NNs in Bayesian frameworks to estimate uncertainty, (see, e.g., Gal, Y., and Ghahramani, Z., Dropout as a Bayesian approximation: Representing model uncertainty in deep learning (2016) in ICML; Kendall, A., and Gal, Y., What uncertainties do we need in bayesian deep learning for computer vision? (2017) in Advances in Neural Information Processing Systems, volume 30; and Malinin, A., and Gales, M., Predictive uncertainty estimation via prior networks (2018) in Advances in Neural Information Processing Systems, volume 31, all of which are hereby incorporated by reference herein), ensemble learning and bootstrap methods to evaluate model uncertainty (see, e.g., Lakshminarayanan, B. et al., Simple and scalable predictive uncertainty estimation using deep ensembles (2017) in Advances in Neural Information Processing Systems, volume 30; and Osband et al., Deep exploration via bootstrapped dqn (2016), in Advances in Neural Information Processing Systems, volume 29, both of which are hereby incorporated by reference herein), and post-processing approaches to calibrate predictive confidence (see, e.g., Guo et al., On calibration of modern neural networks, (2017), in ICML; Kuleshov et al., Accurate uncertainties for deep learning using calibrated regression (2019), in ICML; Liang et al., Enhancing the reliability of out-of-distribution image detection in neural networks (2018), in ICLR, all of which are hereby incorporated by reference herein).

Exemplary embodiments of the present disclosure provide a trustworthy graph AI method for collectively learning configurations of a number of systems, even a massive number of systems. Although the target systems (e.g. agents, virtual machines (VMs), containers) often have no physical connections (e.g. cable-based connections), exemplary embodiments of the present disclosure organize the systems into a graph for use in a neural network. For example, the graph may be configured as a virtual graph of nodes connected by links, the nodes being models of the systems that can be used in a neural network (“system-nodes”). By connecting the system-nodes using links, the graph can be created to capture the systems' correlations explicitly. Then the graph guides the communications between the system-nodes: i.e., a system-node has the ability to transfer information only with its direct neighbors iteratively. Because all system-nodes are connected together, information of a system-node can be transferred to any other system-node on the graph properly, via graph-based mechanisms. Moreover, embodiments of the present disclosure learn uncertainty of the transferred messages, and can propagate not only possible optimal values, but also the confidence of the estimation of uncertainty. Finally, the end users are thus sufficiently informed to decide when to select the AI based solution with increased trust.

Exemplary embodiments of the present disclosure provide an automated deployment and configuration of virtualized systems. Exemplary embodiments provide many solutions, e.g., twofold advantages such as the following: (1) Exemplary embodiments of the present disclosure can automatically generate optimal configurations for deployment of a massive number of systems; (2) Exemplary embodiments of the present disclosure can provide not only optimal values, but also confidence of the estimation. Thus, the system operators can decide how to use the learned results given a predefined confidence level.

For example, exemplary embodiments can provide optimal values (e.g., mean/average) and confidence intervals (e.g., standard deviation (std)) of the resource demands of each vDU. Given the confidence level (e.g., 95%, 99%) predefined by the operator, then the embodiments can set request as the learned mean, and limit as (mean+2*std) for 95% confidence level and (mean+3*std) for 99%. Therefore, exemplary embodiments can clearly provide a trustworthy solution.

A first aspect of the present disclosure provides a method for providing a trustworthy artificial intelligence (AI) graph-based solution for configuring a plurality of systems in a network. The method includes generating a graph in which each node in the graph represents one of the plurality of systems, wherein links are created between the nodes in the graph, and passing messages along the links. Each node passes a message and a level of uncertainty in the message to neighboring nodes of each node, and receives subsequent messages and subsequent levels of uncertainty in the subsequent messages back from the neighboring nodes. The method also includes updating, by each node based on the subsequent messages and the subsequent levels of uncertainty in the subsequent messages that were received from the neighboring nodes, the respective message and the respective level of uncertainty in the respective message, and predicting configuration values for the systems based on the updated messages and the updated levels of uncertainty.

A second aspect of the present disclosure provides the method according to the first aspect, wherein passing the messages along the links comprises propagating the level of uncertainty in the message through the graph from each node to the neighboring nodes of each node, and accounting for the level of uncertainty in the message in each subsequent level of uncertainty in the subsequent message that is passed by the neighboring node of each node which received the level of uncertainty in the message from the node.

A third aspect of the present disclosure provides the method according to the second aspect, wherein accounting for the level of uncertainty in the message further comprises assigning a respective weight to each link, predicting the levels of uncertainty in the message propagated along each link, and adjusting the weight of each link based on values of the predicted levels of uncertainty in the messages propagated along the links.

A fourth aspect of the present disclosure provides the method according to any of the first, second, and third aspects, and further comprises respectively assigning a weight to each of the links and iterating a weight matrix of the graph using the levels of uncertainty in the messages.

A fifth aspect of the present disclosure provides the method according to the fourth aspect, and further comprises using the level of uncertainty in the message to calculate a loss term, and integrating the loss term into the iteration of the weight matrix of the graph.

A sixth aspect of the present disclosure provides the method according to any of the first, second, third, fourth, and fifth aspects, wherein a first node of the nodes models a first distributed unit of an open radio access network, and one of the neighboring nodes, which is a neighbor node of the first node, models a second distributed unit of the open radio access network. Additionally, at least one of the links is created based on a similarity of a physical relationship of a first respective radio unit with the first distributed unit and a physical relationship of a second respective radio unit with the second distributed unit.

A seventh aspect of the present disclosure provides the method according to the sixth aspect, wherein each of the messages communicate a resource demand of a respective distributed unit in the graph, and predicting configuration values for the systems comprises determining an allocation of a resource of the resource demand across the distributed units in the graph.

An eighth aspect of the present disclosure provides the method according to any of the first, second, third, fourth, fifth, sixth, and seventh aspects, wherein passing messages along the links comprises passing, by one of the nodes, the message and the level of uncertainty in the message to at least a first neighboring node which neighbors the node. The eighth aspect also comprises passing, by a second neighboring node which neighbors the first neighboring node, a message of the second neighboring node and a level of uncertainty in the message of the second neighboring node to at least the first neighboring node. The eighth aspect also comprises producing an updated message of the first neighboring node that is a weighted sum of the message of the node and the message of the second neighboring node. The eighth aspect also comprises producing an updated level of uncertainty in the message of the first neighboring node based on the previous level of uncertainty in the message of the node and the level of uncertainty in the message of the second neighboring node to reduce the level of uncertainty of the updated level of uncertainty in the message of the first neighboring node, and passing the updated message and an updated level of uncertainty in the updated message to one of the neighboring nodes of the first neighboring node using the links.

A ninth aspect of the present disclosure provides the method according to any of the first, second, third, fourth, fifth, sixth, seventh, and eighth aspects, wherein the updated level of uncertainty in each node's message is reduced with respect to the level of uncertainty in the message proportionally to the number of neighboring nodes to each respective node.

A tenth aspect of the present disclosure provides the method according to any of the first, second, third, fourth, fifth, sixth, seventh, eighth, and ninth aspects, wherein predicting configuration values further comprises predicting confidence intervals of the predicted configuration values for the systems.

An eleventh aspect of the present disclosure provides the method according to any of the first, second, third, fourth, fifth, sixth, seventh, eighth, ninth, and tenth aspects, wherein updating each node's message and the level of uncertainty in each node's message further comprises using a Gaussian function learned with a local topology of the links.

A twelfth aspect of the present disclosure provides the method according to the eleventh aspect, wherein the Gaussian function for each node is conditioned on the degree of the node.

A thirteenth aspect of the present disclosure provides the method according to any of the first, second, third, fourth, fifth, sixth, seventh, eighth, ninth, tenth, eleventh, and twelfth aspects, further comprising adapting a configuration of at least one of the systems based on the predicted configuration values for the systems.

A fourteenth aspect of the present disclosure provides a system comprising one or more hardware processors which, alone or in combination, are configured to provide for execution of the following steps. The following steps comprise generating a graph in which each node in the graph represents one of a plurality of systems, wherein links are created between the nodes in the graph, and passing messages along the links. Each node passes a message and a level of uncertainty in the message to neighboring nodes of each node, and receives subsequent messages and subsequent levels of uncertainty in the subsequent messages back from the neighboring nodes. The steps also include updating, by each node based on the subsequent messages and the subsequent levels of uncertainty in the subsequent messages that were received from the neighboring nodes, the respective message and the respective level of uncertainty in the respective message, and predicting configuration values for the systems based on the updated messages and the updated levels of uncertainty.

A fifteenth aspect of the present disclosure provides a tangible, non-transitory computer-readable medium having instructions thereon which, upon being executed by one or more hardware processors, alone or in combination, provide for execution of the following steps. The following steps comprise generating a graph in which each node in the graph represents one of a plurality of systems, wherein links are created between the nodes in the graph, and passing messages along the links. Each node passes a message and a level of uncertainty in the message to neighboring nodes of each node, and receives subsequent messages and subsequent levels of uncertainty in the subsequent messages back from the neighboring nodes. The steps also include updating, by each node based on the subsequent messages and the subsequent levels of uncertainty in the subsequent messages that were received from the neighboring nodes, the respective message and the respective level of uncertainty in the respective message, and predicting configuration values for the systems based on the updated messages and the updated levels of uncertainty.

Any of the second, third, fourth, fifth, sixth, seventh, eighth, ninth, tenth, eleventh, twelfth, and thirteenth aspects can also be provided according to the fourteenth or fifteenth aspects.

Embodiments can automatically generate optimal configurations for deployment of a massive number of systems. This can provide huge improvements to system configuration, optimization, deployment, and operation, such as when the number of systems to be configured is large and the configurations of the system are dependent on the configurations of other systems. Moreover, this reduces the cost of deploying the more flexible computing platforms, e.g., edge and cloud computing, instead of the costly and more flexible hardware implemented network functions. By modeling the systems and generating the optimal configurations through the use of a graph, the computation time and computational resources spent optimizing each individual system is reduced by a factor of the number of systems to be configured. Additional, achieving optimized configuration settings reduces computational waste and even energy waste of the systems. Exemplary embodiments can also provide not only optimal configuration settings, but also a confidence level or estimated uncertainty of the solution, which provides additional support when optimizing the configuration settings. The virtualized systems can also make use of the learned results given a predefined confidence level to further improve their performance and functionality, which results in improved computational efficiency and energy efficiency in the deployed systems. For example, by optimizing the configuration settings of correlated systems, the systems collectively improve their technical performance (e.g., improving computational speed/performance, allowing to conserve computational resources, increasing accuracy of system outputs, and/or reducing hardware requirements). Moreover, the solutions are trustworthy and the provided confidence levels allow for further selection of different solutions while taking the uncertainty of these solutions into account, thereby also enhancing flexibility when configuring, optimizing, deploying, and operating the systems.

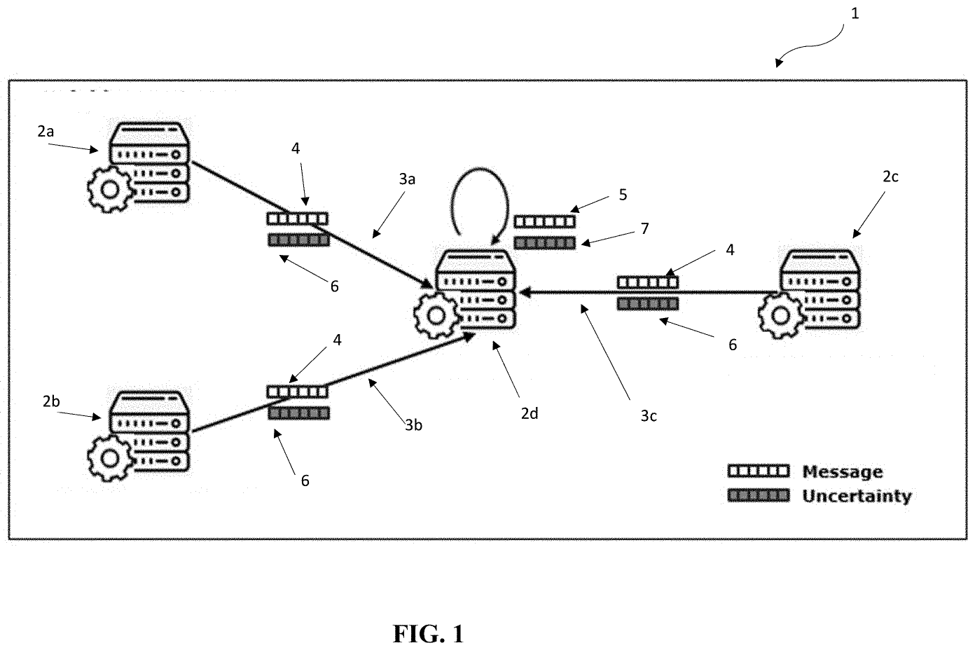

FIG. 1 illustrates an exemplary embodiment of a graph 1 of the present disclosure. There are a set of systems 2a, 2b, 2c, 2d, such as software agents and virtualized network functions (VNFs), that are also neighbor systems. These virtualized systems 2a, 2b, 2c, 2d can each be representative of an individual VNF, or a set of VNFs, and can have attributes of various values, e.g., real or discrete, that are to be predicted. In the graph 1 construction for softwareized systems 2a, 2b, 2c, 2d in the embodiment of FIG. 1, there exist no physical connections (e.g., cable-based connections) between the virtualized softwareized systems 2a, 2b, 2c, 2d. However, these systems 2a, 2b, 2c, 2d often work together as a whole, and present subsistent relations between them. The embodiment of FIG. 1 creates links 3a, 3b, 3c between the systems 2a, 2b, 2c, 2d to encode implicit correlations among them, by which the systems 2a, 2b, 2c, 2d are connected into the graph 1. In particular, the softwareized systems 2a, 2b, 2c, and 2d can each be represented as nodes of the graph 1, and the links 3a, 3b, 3c, can be the edges of the graph 1.

Moreover, the creation of links 3a, 3b, 3c is based on the contexts of the applications, and can use meta information, geographic distances, etc. to create the links. For example, some types of meta information the can be used to create links include the type of area (residence, business, industry, etc.), type and number of POIs (point of interest, restaurant, cinema, tourist destination, etc.), population, and pedestrians. In addition, if handoff traffic between different radio units (RUs) is available, then the handoff traffic information can also be used to help establish the graph. For another example, it is possible to exploit geographic distance between physical sites associated with the virtualized systems 2a, 2b, 2c, 2d. For any pair of systems (i,j), a link is created with a weight w_{i,j}=f(d_{i,j}) where d_{i,j} denotes the distance. The weight function ƒ(⋅) can be of arbitrary form, only if inversely proportion to the distance, e.g. w_{i,j}=exp(−d_{i,j}²/c²). The created links represent the latent but subsistent correlations between systems, and the constructed graph reveals the complicated correlations among the large set of systems. Via the graph 1, the embodiment of FIG. 1 can collectively configure their settings by encoding all correlations.

Message passing in the embodiment of FIG. 1 between systems 2a, 2b, 2c, 2d: over the established graph 1, the systems 2a, 2b, 2c, 2d pass messages 4 and uncertainty 6 of the message with each other, where the messages 4 and uncertainty 6 are represented as vectors of the same dimensions. For example, the messages 4 can be related to a parameter, attribute, etc., of the system 2a, 2b, 2c, 2d to be predicted, e.g., optimal CPU/memory/power consumption, and the uncertainty 6 of the message can be a confidence interval of the message 4. As shown, the exemplary embodiment of FIG. 1 controls how the messages are passed between systems 2a, 2b, 2c, 2d based on the created graph 1: a system 2d collects messages from only its direct neighbors 2a, 2b, 2c on the graph 1 using graph-based mechanisms. The passed message 4 is a vectorized representation of characters/status of a system 2, e.g., an abstraction of the characters of a system 2 and the correlations between systems 2a, 2b, 2c, and 2d. Via the links 3, a system i, such as system 2d in the embodiment of FIG. 1, collects messages from its neighbor systems, such as systems 2a, 2b, 2c in the embodiment of FIG. 1, and updates its own message 4 into an updated message 5 for example with the following equation Eq. (A):

$${m}_{i}^{( ℓ + 1 )} = a ( \begin{matrix}1 \\ \sqrt{{d}_{i}}\end{matrix} {\sum }_{{j}^{′} ∈ N ( i )} \frac{1}{\sqrt{{d}_{j ′}}} {m}_{j ′}^{( ℓ )} {W}^{( ℓ + 1 )} )$$

Here [symbol] denotes the iteration of the message passing communication between the system i and its neighbor j′. α(⋅) denotes an activation function. N(i) is the set of neighbor systems of i. dᵢ means the degree of i over the constructed graph.

Communication between systems 2 on uncertainty 6 of estimated messages 4: as the message 4 is an ML-based estimation, it naturally contains uncertainty 6. Due to emerging requests on trustworthy infrastructure, the uncertainty 6 should be considered properly. Thus, exemplary embodiments associate each message 4 with its estimation uncertainty 6, and operates the communication between systems 2a, 2b, 2c, 2d to pass the uncertainty 6 together. Accordingly, the system i, e.g., system 2d, updates uncertainty 6 of its own message into an updated uncertainty 7 of its own message, based on uncertainty 6 of its neighbors, e.g., systems 2a, 2b, 2c. The propagation mechanism for uncertainty 6 is different from that for messages 4, as uncertainty 6 will reduce when more evidence is available, e.g. more neighbors such as systems 2a, 2b, 2c. The mathematic form of the update function can be flexible if the topology structure of the graph 1 is exploited to ensure that the more neighbors, e.g., systems 2a, 2b, 2c, a system i, e.g., system 2d, has, the less uncertainty 6 that accompanies the new message 4. For example, exemplary embodiments can use a Gaussian process based propagation mechanism to pass uncertainty 6 between systems 2a, 2b, 2c, 2d. In particular, for a system i at the iteration ( [symbol] +1), an exemplary update function of its uncertainty can be Eq. (B):

[symbol]

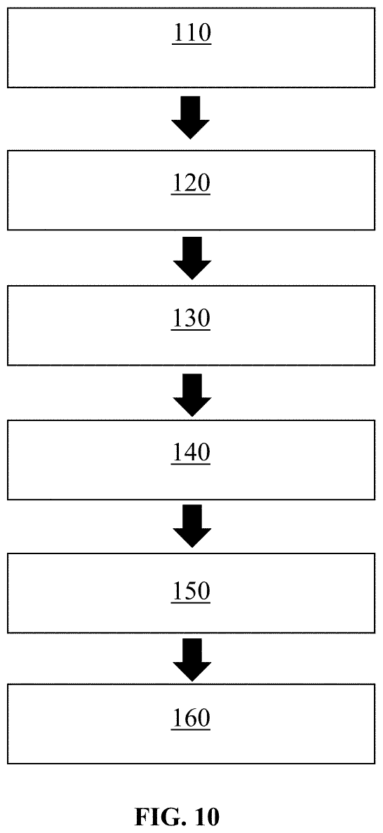

=a(( [symbol] −CB⁻¹C^{T})

[symbol]

where C and B denote covariance among the system i and its neighbors as in FIGS. 11 and B and C below:

$$B = [ \begin{matrix}{u}_{{j}_{1}}^{( ℓ )} & … & cov ( {j}_{n} , {j}_{m} ) \\ ⋮ & ⋱ & ⋮ \\ cov ( {j}_{m} , {j}_{n} ) & … & {u}_{{j}_{Ni}}^{( ℓ )}\end{matrix} ] \\ C = [ cov ( i , {j}_{1} ) , … , cov ( i , {j}_{Ni} ) ]$$

where cov(i,j)=cor(i,j) [symbol] . The normalized correlation is defined with a sub-graph around i; the mathematic form of the correlation function is flexible, e.g. cor(i,j)=1/\sqrt{ξdᵢdᵢ} if there exists a link between the systems i and j, otherwise it is zero. So, for example, in an embodiment utilizing both Eq. (A) and Eq. (B), at the iteration [symbol] +1, each node collects message [symbol] and uncertainty values [symbol] of its neighbors, to update its own message and uncertainty and get an updated message [symbol] and an updated uncertainty [symbol] . At the next iteration, each node updates those two values and gets [symbol] and [symbol] .

While systems 2a, 2b, 2c, 2d can communicate with each other for several iterations about their messages 4 and the uncertainty 6 of the message 4, the final obtained messages 4 and uncertainty 6 can predict the optimal configurations of the systems 2, associated with the corresponding confidence intervals. In particular, is it possible for the confidence interval of each system to be decided separately. Since the correlations between systems have been integrated into neural networks via the constructed graph, the learned std of each system can represent the expected uncertainty. The parameters in exemplary embodiments can be learned using standard gradient decent algorithms with a handful of known configurations. For example, the number of iterations can be a parameter, and can be decided in the training procedure, e.g., with cross-validation.

Systems, e.g., such as systems 2s, 2b, 2c, and 2d of FIG. 1, can run on a processing system. The processing system can include one or more processors, memory, and input/output devices. Processors can include one or more distinct processors, each having one or more cores. Each of the distinct processors can have the same or different structure. Processors can include one or more CPUs, one or more graphics processing units (GPUs), circuitry (e.g., application specific integrated circuits (ASICs)), digital signal processors (DSPs), and the like. Processors can be mounted to a common substrate or to multiple different substrates. Processing systems can be distributed. For example, some components of processing systems can reside in a remote hosted network service (e.g., a cloud computing environment) while other components of processing systems can reside in a local computing system. Processing systems can have a modular design where certain modules include a plurality of the features/functions. For example, input/output modules can include volatile memory and one or more processors. As another example, individual processor modules can include read-only-memory and/or local caches.

Processors can be configured to perform a certain function, method, or operation (e.g., are configured to provide for performance of a function, method, or operation) at least when one of the one or more of the distinct processors is capable of performing operations embodying the function, method, or operation. Processors can perform operations embodying the function, method, or operation by, for example, executing code (e.g., interpreting scripts) stored on memory and/or trafficking data through one or more ASICs. Processors, and thus the processing system, can be configured to perform, automatically, any and all functions, methods, and operations disclosed herein. Therefore, the processing system can be configured to implement any of (e.g., all of) the protocols, devices, mechanisms, systems, and methods described herein.

Memory can include volatile memory, non-volatile memory, and any other medium capable of storing data. Each of the volatile memory, non-volatile memory, and any other type of memory can include multiple different memory devices, located at multiple distinct locations and each having a different structure. Memory can include remotely hosted (e.g., cloud) storage.

Examples of memory include a non-transitory computer-readable media such as RAM, ROM, flash memory, EEPROM, any kind of optical storage disk such as a DVD, a Blu-Ray® disc, magnetic storage, holographic storage, a HDD, a SSD, any medium that can be used to store program code in the form of instructions or data structures, and the like. Any and all of the methods, functions, and operations described herein can be fully embodied in the form of tangible and/or non-transitory machine-readable code (e.g., interpretable scripts) saved in memory.

Exemplary embodiments can also include 5G network applications, such as the configuration of resource demands for ORAN distributed units (DUs) on cloud/MEC (multi-access edge computing).

Exemplary embodiments can be used for setup, for example for setup of CPU resource and memory resource for DUs of ORAN. Exemplary embodiments can also configure the settings of DUs about CPU and memory usages. In particular embodiments, to deploy vDUs on edge, the operators have to manually specify requests and limits of CPU/storage usage for each vDUs. The parameter request relates to how much resource is needed on average, while the parameter limit means the maximum amount of resource for the vDU. With exemplary embodiments of the present disclosure, the operators can automatically configure the parameters of a massive number of vDUs properly.

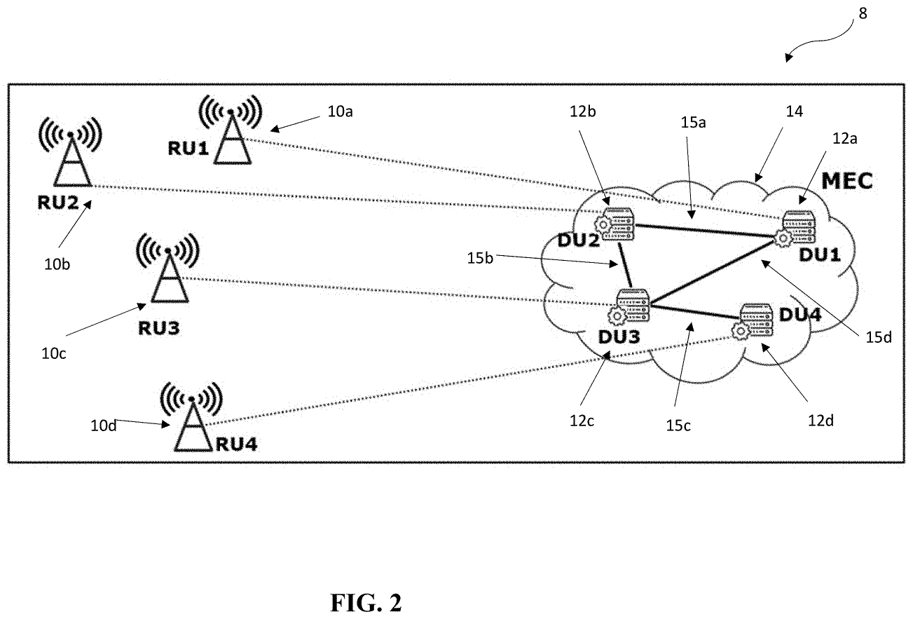

FIG. 2 illustrates the basic concept of an exemplary ORAN deployment 8. RUs 10 are located at the antennas. A DU 12 is associated with each RU, and is deployed at MEC 14 or Cloud.

Due to constraints of the 5G spectrum, the number of RUs 10/DUs 12 increases dramatically. It may not be realistic to request an operator to configure each DU 12 manually. In particular, the fronthaul distance (i.e. connectivity between RUs 10 and DUs 12) is typically about 10 km to meet the very low latency requirement of 5G network, while the service range of 5G mmWave is approximately 500 meters in a test environment. Thus, an area with a radius of 10 km (e.g., a small city like Heidelberg) needs >400 DUs 12.

Exemplary embodiments of the present disclosure provide many unique properties. For example, exemplary embodiments can consider correlations between DUs 12, and collectively configure a large set of DUs 12 with optimal values. Moreover, exemplary embodiments can provide confidence of the solution, by which operators acquire the knowledge of when to trust the AI-based solution. This meets the emerging request of the EC on trustworthy infrastructure.

Exemplary embodiments can also cause a physical change (technicity), by configuring ORAN DUs 12 of 5G network.

Exemplary embodiments of the present disclosure can be applied to public safety, such as the configuration of camera based surveillance systems. In use, public surveillance cameras are installed at different physical sites for public safety. The softwareized systems 2 are associated with them to process the site-specific data, e.g. face recognition and people entity detection. Exemplary embodiments of the present disclosure can be used to configure the systems 2 as part of management and orchestration control. Particular embodiments of the present disclosure help operators automatically configure a massive number of virtualized systems 2, e.g. setting up the parameters (such as averaged resource usage, limit of resource usage, degree of accuracy, number of frames) of the systems 2. Here exemplary embodiments can also integrate the information about the number of emergency calls into graph construction, such as graph 1, such that the surveillance systems, e.g., systems 2, can be configured according to the security requirements of the areas. Intuitively, a place with many emergency calls should obtain more attention, i.e., finer granularity (resolution, number of frames) of the collected images, higher accuracy of image processing results, and more resource usage to store/process the detailed data. Exemplary embodiments of the present disclosure can consider the factors when configuring systems, such that the places with similar number of emergency calls intend to obtain similar parameter settings of the virtualized surveillance systems.

In addition, although the virtualized systems 2 are related to image processing, exemplary embodiments themselves may not access the image data, and are not endowed with the capability of addressing the image data. Since exemplary embodiments may not access any personal data, misuse problems can be avoided. Configuring a massive number of systems 2 manually is a tricky task for operators. Exemplary embodiments of the present disclosure aim to facilitate the operators in automatically setting up optimal configurations of the set of softwareized systems 2. The quantified solution with uncertainty 6 estimation will address the pain points of the operators in compliance with the emerging requests for trustworthy infrastructure.

Exemplary embodiments of the present disclosure provide many unique properties. For example, exemplary embodiments can consider correlations between cameras, including geographical relations and properties of the covered areas. Exemplary embodiments can also provide uncertainty of AI-based configuration solutions, such that the operators can designate confidence level to have trustworthy settings.

Exemplary embodiments can also cause a physical change (technicity), by setting up unknown configurations of a number of camera-based surveillance systems of a city/area, even a massive number. For example, the camera based surveillance systems are often cloud native, either for flexibility or cost considerations. Each camera is on the front end, which are used to get videos, and can be connected with image processing and storage units implemented as virtual systems and deployed on the cloud. Exemplary embodiments can set up the configurations via the virtual systems, which also means that the configurations are set on the cloud when deploying them. Additionally, this can provide for the possibility of updating those configurations afterwards via use of the same virtual systems and cloud relationship.

Exemplary embodiments of the present disclosure integrate uncertainty 6 estimation in message 4 passing between connected systems 2, where the uncertainty 6 is propagated among the system 2d and its neighbors 2a, 2b, 2c using the conditional Gaussian learned with the local topology of the graph and iterates of the model's weight matrixes.

FIG. 2 provides another exemplary embodiment of the present disclosure for a set of systems, such as DUs 12a, 12b, 12c, and 12d, comprising creating links 15, such as the links 15a, 15b, 15c, 15d between the systems 12 to capture their potential common behavior. For example, for DUs 12 of ORAN, the DUs can be virtualized as a node, and the links 15 can be created as per distance/similarity of the RUs 10 corresponding to the respective DU 12 with respect to geographical location and meta data (points of interest (POI), etc.). The systems 12 can be connected into a graph via the created links 15. In an embodiment, the graph makes up part of a neural network for the same purpose. This graph guides communications between systems 12 to pass the configuration predictions and uncertainty of the predictions. Each system 12a, 12b, 12c, 12d communicates with its neighbors 12a, 12b, 12c, 12d on the graph to collect their message 4 and uncertainty 6 of the message and update its own message 4 and uncertainty 6 into an updated message 5 and uncertainty 7. Since each node, such as the DU 12c communicates with its neighbors 12a, 12b, 12d, the message 4 and the uncertainty 6 can propagate over the entire graph. If there exists a path between any pair of nodes, e.g., any pair of DUs 12a, 12b, 12c, 12d, the message 4 and the uncertainty 6 can be passed in between for configuration estimation. When converging, the learned message 4 and uncertainty 6 is used to predict optimal configuration values and the confidence of the AI-driven solution.

Exemplary embodiments of the present disclosure, in contrast to existing technology, can provide many improvements, such as:

automatically generating optimal configurations for deployment of a massive number of systems.

providing not only optimal estimation, but also confidence of the estimation. Therefore, the system operators can decide how to use the learned results given a predefined confidence level, which matches the emerging requirements about trustworthy infrastructure.

Exemplary embodiments can be used in many applications where a number of correlated systems have unknown configurations (discrete or continuous numbers), even massive numbers, and need to be set up automatically. For example, it can be used in ORAN and public safety.

Exemplary embodiments of the present disclosure provide for graph construction and confidence estimation of predicted configurations. Exemplary embodiments can also request for users to provide information for graph construction, and embodiments can take place in the public domain. Hence, the functionality of the system may be disclosed with enough details to avoid unequal treatment or other (social) preferences.

Exemplary embodiments of the present disclosure, in the setup of unknown configurations of a massive number of correlated systems, provide improvements to the performance and functionality of the correlated systems, in addition to beneficial secondary effects. For example, in addition to the exemplary embodiment of FIG. 1 about resource-related configuration, exemplary embodiments reduce the costs of operators by reducing the necessary hardware capabilities. Moreover, by optimizing deployment, exemplary embodiments can save energy and provide a more-energy efficient solution.

An exemplary embodiment has been tested with a simple graph dataset Cora. Table 1 shows the results of an embodiment of the disclosure vs. the methods of GCN, GAT and VGCN. The dataset includes 2708 nodes. Each node has a single configuration variable, which specifies the label of the node with seven possible states. In the training, the configurations of 5/10/15/20 nodes per state are given, separately. In the test, the exemplary embodiment estimates the configuration states of the test nodes, and measures the performance with average calibration error (ACE) and expected calibration error (ECE) that are commonly used criteria for reliability of predictions, i.e., calibration. The smaller the scores are, the more reliable the predictions are.

TABLE 1

| | Inventive Solution | | | | GCN | | | |
|---|---|---|---|---|---|---|---|---|
| Metrics | 5 | 10 | 15 | 20 | 5 | 10 | 15 | 20 |
| ACE | 9.78 | 9.45 | 9.9 | 10.03 | 19.43 | 19.22 | 18.93 | 18.8 |
| ECE | 7.82 | 6.93 | 6.9 | 6.8 | 23.14 | 21.68 | 20.75 | 20.06 |
| | GAT | | | | VGCN | | | |
| Metrics | 5 | 10 | 15 | 20 | 5 | 10 | 15 | 20 |
| ACE | 47.99 | 47.2 | 40.95 | 40.07 | 10.65 | 12.03 | 11.74 | 10.67 |
| ECE | 50.38 | 52.08 | 49.46 | 48.68 | 10.63 | 11.29 | 10.28 | 9.58 |

The method of the exemplary embodiment provides well-calibrated (i.e. reliable) results. Since the exemplary embodiment clearly considers the uncertainty 6 of the messages 4, the predictions are more reliable.

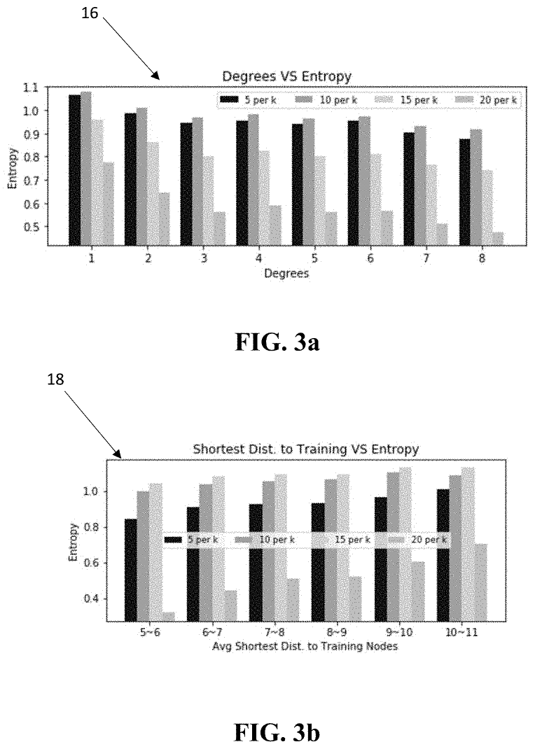

FIGS. 3a and 3b illustrates the relations between the learned uncertainty of the prediction 6 and the graph topology of the exemplary embodiment tested with the sample dataset Cora. Panel 16 of FIG. 3a is the uncertainty (i.e. entropy) versus the number of neighbors (i.e. degree of nodes). The panel 16 shows that the uncertainty decreases with the increase of the degree. Panel 18 of FIG. 3b is the learned uncertainty versus the averaged distance between the test node and the training nodes. The longer the distance, the larger the uncertainty. FIGS. 3a and 3b demonstrate that the uncertainty of the predictions are learned properly for the exemplary embodiment, which exactly matches the intuitions.

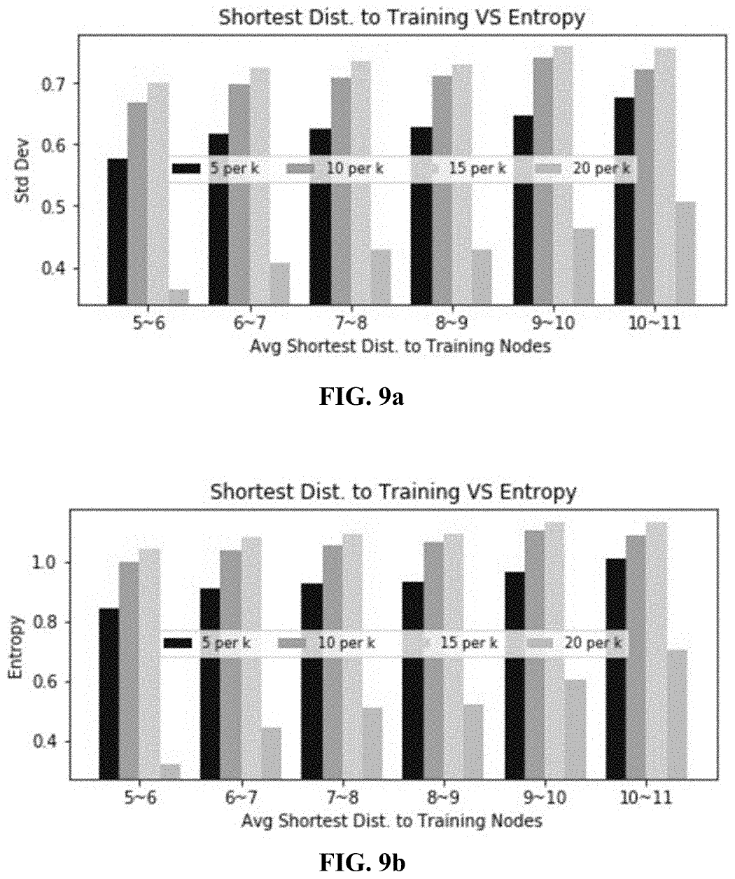

FIG. 10 depicts an exemplary process and method for configuring a number of systems. At step 110, each system in a network is modeled by a node and a graph is generated by creating links between the nodes. At step 120, messages are passed along the link of the node. When passing messages, the node passes a message and a level of uncertainty in that message to its neighboring nodes. At step 130, the node then also receives subsequent messages and subsequent levels of uncertainty in those subsequent messages back from the neighboring nodes. At step 140, the node updates its own message and its own level of uncertainty in its own message based on the subsequent messages and the subsequent levels of uncertainty in those subsequent messages that the node received in step 130. At step 150, the configuration values and confidence intervals for the systems in the network can be predicted based the updated messages and updated levels of uncertainty in the updated messages of the nodes modeling the systems. While any of steps 110, 120, 130, 140, and 150 are capable of repetition, steps 120, 130, and 140 can also be repeated a sufficient number of times to provide appropriate updated messages and updated levels of uncertainty for step 150. At step 160, the predicted configuration values for the systems are propagated into the functioning of the systems at deployment, configuration, operation, etc. Propagation can occur via the cloud for cloud native systems, or through or any others means able to communicate with the systems, including physical set up.

The following references are incorporated in their entirety by reference herein:
A. Malinin and M. Gales. 2018. Predictive uncertainty estimation via prior networks. In NIPS 31.
A. Kendall and Y. Gal. 2017. What uncertainties do we need in Bayesian deep learning for computer vision? In NIPS 30.
T. Kipf and M. Welling. 2016. Semi-supervised classification with graph convolutional networks. In ICLR.
H. Salimbeni and M. Deisenroth. 2018. Doubly stochastic variational inference for deep Gaussian processes. In NIPS 31.

In the following, further information and description of exemplary embodiments of the present disclosure are provided in further detail. To the extent the terminology used to describe the following embodiments may differ from the terminology used to describe the preceding embodiments, a person having skill in the art would understand that certain terms correspond to one another in the different embodiments.

Quantifying predictive uncertainty of NNs has recently attracted increasing attention. Embodiments of the present disclosure measure uncertainty of graph neural networks (GNNs) for the task of node classification. Most existing GNNs model message passing among nodes. A variety of mechanisms are introduced to propagate the node messages over the graphs. The learned messages are often deterministic. Embodiments of the present disclosure recognize that embedding GNNs in a Bayesian modeling framework, and introducing a novel method to model predictive uncertainty of node classification with Bayesian confidence of predictive probability and uncertainty of messages addresses several issues, such as whether uncertainty exists in the messages, how to propagate uncertainty over a graph together with messages, and whether message passing mechanisms apply to uncertainty passing. Embodiments of the present disclosure also propose an uncertainty propagation mechanism inspired by Gaussian models, and present an uncertainty oriented loss for node classification that allows the GNNs to clearly integrate predictive uncertainty in learning procedure. Consequently, the training nodes with large predictive uncertainty will be penalized, and contribute less in the loss. Embodiments are demonstrated with respect to prediction reliability and OOD predictions. The learned uncertainty is also analyzed in depth. The relations between uncertainty and graph topology, as well as predictive uncertainty in the OOD cases are investigated with extensive experiments. The empirical results with popular benchmark datasets show the superior performance of embodiments of the present disclosure.

Embodiments also relate to computing methodologies such as AI; semi-supervised learning settings; and NNs, e.g., GNNs, uncertainty quantification, classification.

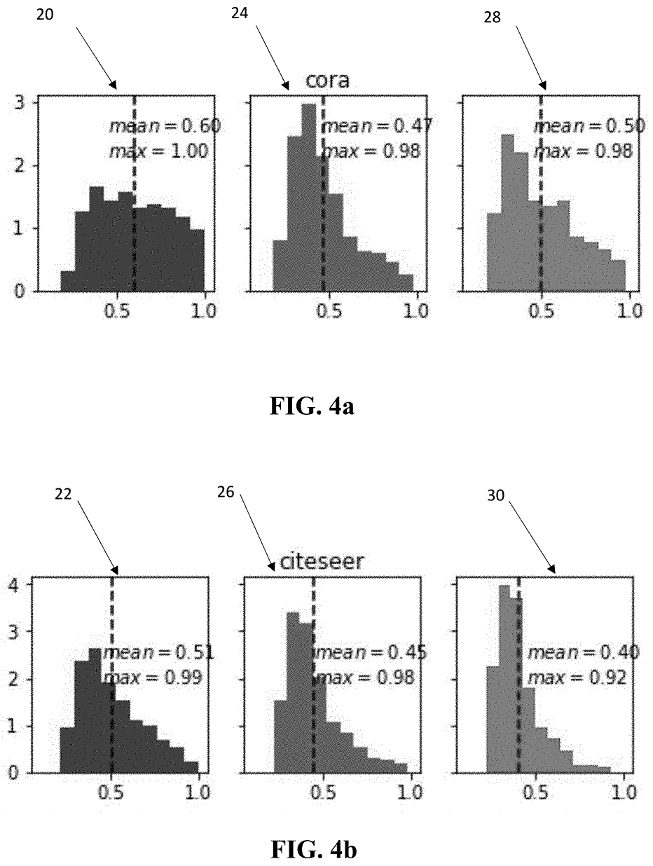

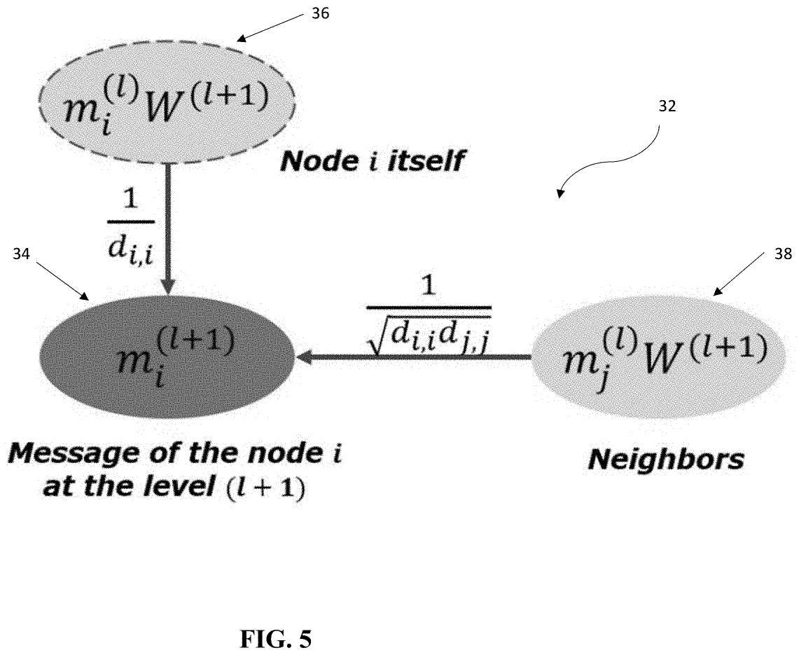

For graph data, modeling predictive uncertainty is also a problem. In node classification, the uncertainty is often represented as predictive probability (confidence), and computed with GNNs. FIGS. 4a and 4b visualize distributions of confidence, computed with a GCN, for node classification in the citation networks Cora and citeseer. In each dataset, there are normal and OOD nodes. The OOD nodes are nodes from the classes that are not observed in the training data. FIG. 4a shows the Cora network panels that display confidence distributions for InDist nodes 20 (left), InDist nodes with false classification 24 (middle), and OOD nodes 28 (right); FIG. 4b shows the citeseer network panels that display confidence distributions for InDist nodes 22 (left), InDist nodes with false classification 26 (middle), and OOD nodes 30 (right). The statistics of the confidence for the three types of test nodes are similar. In detail, the middle panels 24, 26 reveal that the GNN method is confident of its false predictions. The right panels 28, 30 show similar tendencies for the OOD case: though the GNN does not learn any knowledge in terms of the OOD nodes (of unobserved classes), it can still classify them to the observed classes with high confidence. The example demonstrates that in the node classification problem, a more sophisticated manner is needed to properly model the predictive uncertainty.

To meet this challenge, embodiments of the present disclosure investigate predictive uncertainty of NNs for node classification via modeling Bayesian confidence of the predictive probability and the uncertainty of the messages. In particular, embodiments learn distribution of predictive probability based on message uncertainty. Most existing GNNs model message passing among nodes. Each node is associated with a message, represented as a vector. Through the links, the messages flow over the entire graph, such that the evidence can properly be shared by all inter-connected nodes. The messages are often assumed to be deterministic, i.e. unknown but fixed, with no uncertainty modeled. However, the messages are learned from the data, and thus uncertainty naturally exists. It is reasonable to model the messages as unknown and random. By integrating uncertainty of messages, embodiments can then model distribution of predictive probabilities, which allows for quantification of uncertainty in predictions in an elegant manner.

When the message of a node is transferred to its neighbors, the uncertainty of the message will be passed accordingly. Not only the messages, but also their uncertainty flow over the entire graph, such that any node can properly estimate the uncertainty of its prediction conditioned on all uncertainty of all nodes. Regarding the question of how to propagate the uncertainty among nodes, a straightforward solution would be to directly use the message passing mechanism, e.g. (GCN), to propagate the uncertainty. However, such message passing mechanisms do not easily apply to uncertainty propagation. Intuitively, predictive uncertainty of a node i should be lower than that of another node j if the node i is connected to more neighbors, since more evidence will be flowed to the node via the links. However, the message passing mechanism behaves reversely, which will lead to larger uncertainty for the well-connected nodes, or at least provide no guarantee that the uncertainty will be decreased. To solve the problem, embodiments of the present disclosure provide a new uncertainty propagation mechanism based on conditional Gaussian models. The uncertainty of a node i is conditioned on uncertainty of its neighbors. The more neighbors it connects with, the less uncertain its predictive probability. And the more uncertain its neighbors are about the passed messages, the more the uncertainty of the node will increase accordingly. In addition, embodiments provide an uncertainty-oriented loss for node classification, that explicitly integrates the predictive uncertainty in the training process. Beyond the commonly used cross entropy loss, the embodiments penalize the predictions with high uncertainty. The novel loss is model agnostic, and can also be applied to other classification issues. To demonstrate the performance of the embodiments, experiments investigated: the reliability of the embodiments for the InDist nodes, the learned uncertainty for the OOD nodes, as well as the relationship between the learned uncertainty and the graph topology.

Uncertainty quantification is used in practical applications of NNs. There has recently been notable progress on uncertainty modeling, including Bayesian and non-Bayesian methods for graph and non-graph data.

Bayesian NNs for model uncertainty: Instead of learning point estimation of NN parameters, Bayesian methods assume the parameters follow certain prior distributions and learn their posterior to best fit the data. This modeling strategy quantifies the uncertainty of the models themselves, (also known as epistemic uncertainty that can be reduced with increasing size of data), and thus often generalize better. Due to computational complexity of Bayesian NNs, a variety of approximation methods have been introduced. Among the pioneer works, MacKay introduced a practical Bayesian framework for backpropagation (see MacKay, D., A practical bayesian framework for backpropagation networks (1992), Neural Computation 4(3):448-72, which is hereby incorporated by reference herein), and Neal proposed the first Monte Carlo (MC) sampling method to learn Bayesian NNs (see Neal, R., Bayesian learning via stochastic dynamics (1993), in Advances in Neural Information Processing Systems, volume 16, which is hereby incorporated by reference herein). Recently, Welling and Teh presented stochastic gradient Langevin dynamics to approach the true posterior distribution of the parameters (see Welling, M., and Teh, Y., Bayesian learning via stochastic gradient langevin dynamics (2011), in ICML, which is hereby incorporated by reference herein). Blunder et al. and Graves extended the Bayesian backpropagation to large scale data. See Blundell, C. et al., Weight uncertainty in neural networks (2015), in ICML, and Graves, A., Practical variational inference for neural networks (2011), in Advances in Neural Information Processing Systems, volume 24, which are hereby incorporated by reference herein. Gal and Ghahramani, 2016, as well as Kingma et al. proposed dropout-based variational inference (see Kingma, D. et al., Variational dropout and the local reparameterization trick (2015), in Advances in Neural Information Processing Systems, volume 28, which is hereby incorporated by reference herein). Other works include searching for the approximation to the true posterior (see, e.g., Rezende, D. J., and Mohamed, S., Variational inference with normalizing flows (2015), in ICML, which is hereby incorporated by reference herein) and learning parameter dependencies (Louizos, C., and Welling, M., Structured and efficient variational deep learning with matrix gaussian posteriors (2016), in ICML, which is hereby incorporated by reference herein).

In addition, Bayesian NNs are also used to model data uncertainty (a.k.a. aleatoric uncertainty). For example, Kendall and Gal (2017) combined model uncertainty and data uncertainty with a Bayesian framework for image segmentation and depth regression. Malinin and Gales (2018) extended Kendall and Gal (2017) to address model uncertainty, data uncertainty and distributional uncertainty for in-domain misclassification detection and out-of-distribution (OOD) input detection of image data.

Non-Bayesian methods for uncertainty estimation: Bayesian NNs advance the state-of-the-art of uncertainty estimation for deep neural networks (DNN), however the concern about computational complexity still exists. Another line of research is to compute the parameter distributions with non-Bayesian techniques. For example, Osband et al. (2016) proposed a boot-strap method and Lakshminarayanan et al. (2017) introduced an ensemble learning method to estimate model uncertainty. Ritter, H. et al., A scalable laplace approximation for neural networks (2018), in ICLR, which is hereby incorporated by reference herein, proposed a Kronecker factored Laplace approximation to obtain the posterior of the NN parameters. The method was utilized to estimate model uncertainty for OOD images and the adversarial attack cases.

Prediction calibration: calibration is a notion from frequentist about uncertainty estimation. Unlike a Bayesian framework that models randomness of the parameters, the calibration approaches, e.g., Dawid, A., The well-calibrated Bayesian (1982), in Journal of the American Statistical Association; DeGroot, M., and Fienberg, S., The comparison and evaluation of forecasters (1983), in The statistician; and Naeini, M. et al., Obtaining well calibrated probabilities using bayesian binning (2015), in AAAI, all of which are hereby incorporated by reference herein, focus on the deviation between the inferred predictions and the empirical long-run frequencies. Guo (2017) presented that the modern DNNs are not well-calibrated, and analyzed the reasons with extensive experiments. A post-processing calibration method, temperature scaling, was employed to alleviate the mis-calibration problem. Liang et al. (2018) extended the work by adding adversary examples to distinguish in- and out-of-distribution images. Inspired by Platt scaling, Kuleshov et al. (2018) presented a new recalibration procedure for classification, which requires a sufficient amount of i.i.d. data to produce well-calibrated confidence estimates. Kumar, A. et al., Verified uncertainty calibration (2019), in Advances in Neural Information Processing Systems, volume 32, which is hereby incorporated by reference herein, introduced a scaling-binning calibrator, which combines the ideas of Platt scaling and histogram binning, to reduce sample complexity and meanwhile have a measurable calibration error.

Bayesian graph NNs: the aforementioned methods mostly focus on non-graph data, especially images. There are some works that investigated uncertainty in graphs. In particular, the randomness of the graph structure is explored. For example, Zhang, Y. et al., Bayesian graph convolutional neural networks for semi-supervised classification (2019), in AAAI, which is hereby incorporated by reference herein, combined GCNN and mixed-membership stochastic block model to learn the joint posterior of the random graph (parameters) and the node labels. Zhang, Y's method is more robust against noisy links. Ma, J. et al., A flexible generative framework for graph-based semi-supervised learning (2019), in Advances in Neural Information Processing Systems, volume 32, which is hereby incorporated by reference herein, investigated a flexible generative GNN, which models the joint distribution of the node features, labels, and the graph structure. Wang, H. et al., Graph stochastic neural networks for semi-supervised learning (2020), in Advances in Neural Information Processing Systems, volume 33, which is hereby incorporated by reference herein, proposed a graph stochastic neural network to learn the distribution of the classification function, and tailored the amortized variational inference to approximate the intractable joint posterior. Elinas, P. et al., Variational inference for graph convolutional networks in the absence of graph data and adversarial settings (2020), in Advances in Neural Information Processing Systems, volume 33, which is hereby incorporated by reference herein, extended the GNNs to the scenarios where no input graph topology is available or there exist noisy edges. The authors assume a prior distribution over graphs and learn the graph posterior and the GNN parameters with a variational inference method.

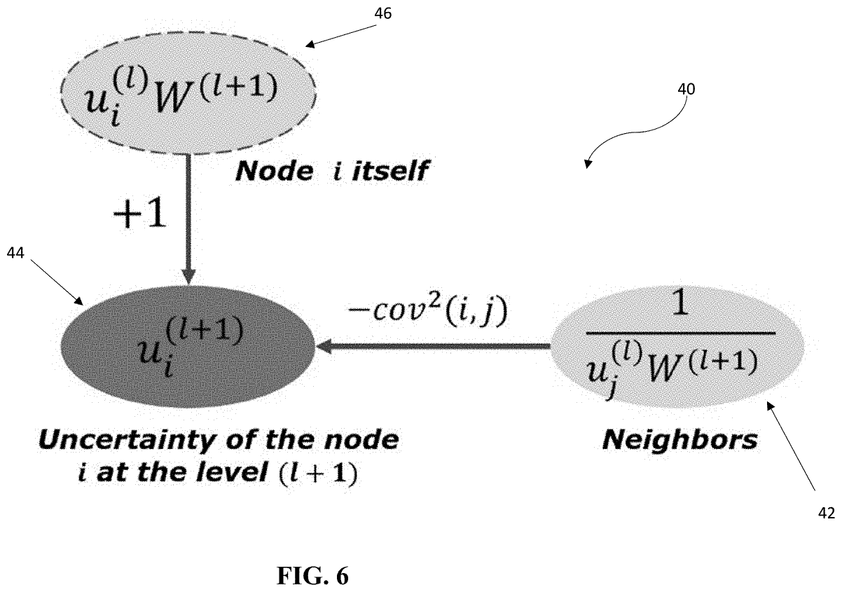

MESSAGE PASSING IN GNNS: FIG. 5 provides an exemplary embodiment of message passing with a graph convolutional neural network (GCNN) 32. The embodiment of FIG. 5 defines a kernel as follows to propagate messages:

$$K = {D}^{- \frac{1}{2}} \hat{A} {D}^{- \frac{1}{2}} , {d}_{i , i} = {\sum }_{j} {\hat{a}}_{i , j} , \hat{A} = A + I , \qquad ( 1 )$$

where A denotes adjacency matrix of a graph, and I is the identity matrix corresponding to extra self-loops of the nodes. The kernel can be decomposed as the following message passing process, shown as in the embodiment of FIG. 5: given a node i, 36, the message 34 of a node i at the layer [symbol] +1 is the weighted sum of the messages of all directly connected nodes (i.e. neighbors 38 of i, denoted as N(i)) at the layer [symbol] . Formally, the messages 34 are transferred and updated as:

$${m}_{i}^{( ℓ + 1 )} = a ( \begin{matrix}1 \\ \sqrt{{d}_{i , i}}\end{matrix} {\sum }_{j ′ ∈ N ( i )} \frac{1}{\sqrt{{d}_{j ′ , j ′}}} {m}_{j ′}^{( ℓ )} {W}^{( ℓ = 1 )} ) \qquad ( 2 )$$

where d_{i,i} denote the degree of the node i, 36. a(⋅) is an activation function. As the GCNN introduces extra self-loops, the node i, 36, is also its own neighbor i∈N (i). Note that the message passing of GCNN is a deterministic process, and no randomness or uncertainty of the messages themselves is considered.

UNCERTAINTY MODELING: Quantifying predictive uncertainty of DNNs is an important but yet unsolved problem. The recent literature has demonstrated that the predictions of DNNs are often overconfident. See, e.g., Hendrycks, D., and Gimpel, K., A baseline for detecting misclassified and out-of-distribution examples in neural networks (2016), in ICLR; Nguyen, A. et al., Deep neural networks are easily fooled: High confidence predictions for unrecognizable images (2015), in CVPR; and Ovadia, Y. et al., Can you trust your model's uncertainty? Evaluating predictive uncertainty under dataset shift (2019), in Advances in Neural Information Processing Systems, volume 32, all of which are incorporated by reference herein. The DNN models may predict wrong class labels with high probabilities in many applications. FIGS. 4a and 4b visualize the problem in graph data with class predictions for InDist nodes and OOD nodes. they reveal that the predicted class probability does not necessarily match the uncertainty of the prediction. However, the commonly used uncertainty measurement tools, e.g., confidence interval, do not apply in classification problems, as class labels are discrete variables with no confidence interval.

Embodiments of the present disclosure will model the uncertainty of the prediction via distribution of the predictive probability based on Bayesian confidence that helps to appropriately quantify predictive uncertainty for node classification. Typically, GNN classifiers learn class label yᵢ of a node i via a discrete probabilistic function

p(yᵢ|X,A):=softmax(θᵢ);θᵢ=ƒ(X,A;ϕ), (3)

where yᵢ∈{0,1}^{C} is a one-hot vector. The function (⋅) is defined using a GNN function with node features X and adjacency matrix A as inputs, and ϕ as parameters. The predictive probability p(yᵢ|X,A) is deterministic given the GNN (⋅). Here, Bayesian confidence is introduced to include extra flexibility. In particular, the classifier is embedded in a Bayesian framework: modeling the probabilistic distribution of p(y|X,A), and using a confidence interval of p(y|X,A) to derive prediction uncertainty. Formally, this results in

p(yᵢ|X,A)=∫p(yᵢ|θᵢ)p(θᵢ|X,A) (4)

and, if the message θᵢ∈ [symbol] ^{C} of the node i follows a C-dimensional Gaussian:

p(θᵢ|X,A)= [symbol] (mᵢ,Σᵢ);mᵢ=g(X,A;γ);Σᵢ=h(X,A;ψ) (5)

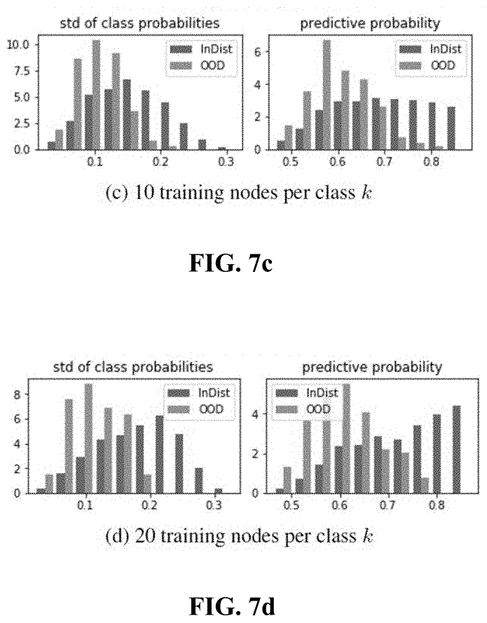

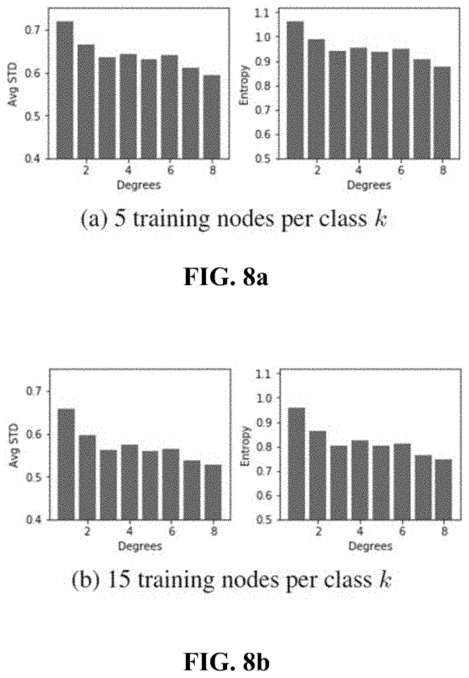

The covariance matrix Σᵢ is often assumed to be diagonal. The mean function mᵢ and the covariance function Σᵢ can be defined with GNNs g(⋅) and h(⋅), separately. By introducing extra uncertainty of the messages, the framework can capture the predictive uncertainty of the node classification. The larger the variance Σᵢ of the message θᵢ, the larger the Bayesian confidence interval of the predicted probability, and thus the prediction is more uncertain. Since the message is multi-dimensional, the averaged variance and the entropy of the Gaussian can be used as scores to quantify the predictive uncertainty. Note that the Gaussian entropy is also related to the geometry of the Gaussian, which can be viewed as a criterion about the volume of the multi-dimensional Gaussian ellipse. FIGS. 7 and 8 visualize the uncertainty scores in the experiments below regarding the embodiment of the method of Q1 and the embodiment of the method of Q2.

In the literature, Malinin and Gales (2018) and Sensoy, M. et al., Evidential deep learning to quantify classification uncertainty (2018), in Advances in Neural Information Processing Systems, volume 31, which is hereby incorporated by reference herein, investigated similar uncertainty for image data, but they used Dirichlet instead of Gaussian to model the distribution of the class probability. The Gaussian prior introduced here would be more suitable for the graph data due to message passing and uncertainty propagation between nodes. Sensoy et al. (2018) named such uncertainty as distributional uncertainty and Malinin and Gales (2018) explained the uncertainty with Dempster-Shafer Theory (DST). See, e.g., Dempster, A., A generalization of bayesian inference (2008), in Classic works of the Dempster-Shafer theory of belief functions, 73-104; and Josang, A., Subjective Logic: A Formalism for Reasoning Under Uncertainly (2016), Springer, both of which are hereby incorporated by reference herein.

In addition, embodiments of the uncertainty modeling mechanism of the present disclosure are orthogonal to epistemic uncertainty, which models uncertainty of model parameters. It is straightforward to add the model uncertainty over embodiments of the uncertainty modeling mechanism:

p(yᵢ|X,A)=∫p(yᵢ|θᵢ) [symbol] (θᵢ|X,A,γ,ψ)p(γ)p(ψ). (6)

There are some works modeling uncertainty of a graph itself, such as Elinas et al. (2020), Ma et al. (2019), Zhang et al. (2019). These can be integrated into embodiments of the present disclosure by

p(yᵢ|X,A)=∫p(yᵢ|θᵢ) [symbol] (θᵢ|X,A)p(A). (7)

### Uncertainty Propagation

Embodiments can model the uncertainty of the messages (C-dimensional Gaussian). A straightforward way of propagating the uncertainty when passing messages among nodes in a GNN framework could be: learning two GCNNs g(⋅) and h(⋅) for a mean and variance of the Gaussian, respectively, then using the reparameterization trick and MC gradient estimator to optimize the parameters. However, the commonly-used message passing mechanism may not work well when propagating uncertainty.

Intuitively, if a node i is connected with multiple nodes, a reasonable estimation is that the prediction uncertainty of the node should be smaller than that of another node which has less links, since the prediction of the node i will be computed conditioned on more evidence. The intuition cannot be matched with the popular message passing mechanism, e.g., Eq. (2), where there is no guarantee that linking to more neighbors leads to less uncertainty in prediction. To model predictive uncertainty of the inter-connected nodes properly, another mechanism is introduced to formulate uncertainty propagation over the graph, inspired by and improving over the Gaussian process of Rasmussen, C., and Williams, C., Gaussian Processes for Machine Learning (2006), MIT Press, which is hereby incorporated by reference herein, which defines a collection of random variables, any finite number of which have a joint Gaussian distribution. The conditional variance of an example with attributes x_{*} is computed as:

var(y_{*})=k_{*,*}−k_{*}^{T}K⁻¹k_{*}.

k_{i,j} is covariance between the examples i and j, which is computed using a kernel function. The first term of the predictive variance can roughly be understood as the prior variance (uncertainty) of the example, while the second term specifies uncertainty deduction due to dependency on the other examples. Building on the predictive variance of the Gaussian process, the following uncertainty propagation mechanism for inter-connected nodes is introduced.

At each layer, the message vectors of all nodes are assumed to follow Gaussian. For a subset of nodes, a node i and its neighbors N(i), each dimension of their messages follow a (Nᵢ+1)-dimensional Gaussian, where Nᵢ denotes the cardinality of N(i). The covariance can be defined with the links between i and N(i).

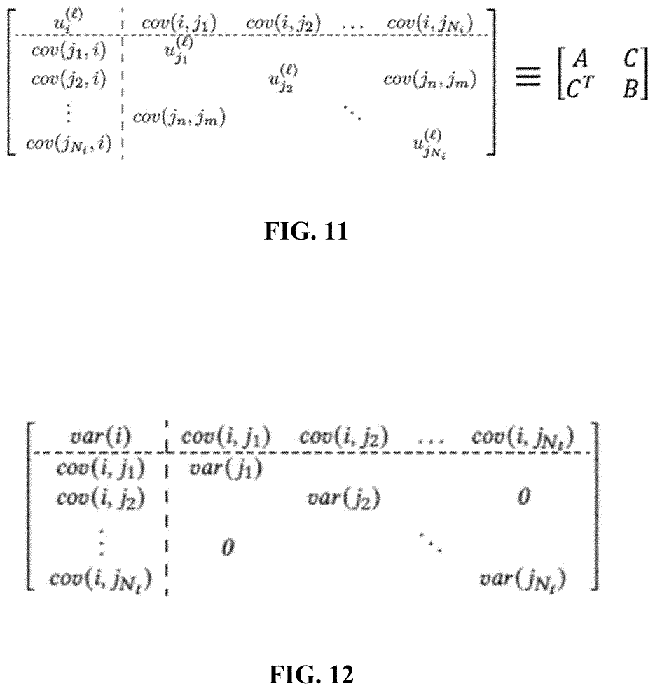

Definition 1: The covariance matrix between the node i and its neighbor N (i) is a block matrix of the type shown in FIG. 12 with the covariance:

cov(i,j)=cor(i,j)(var(i)var(j))^{1/2};cor(i,j)=(ξd_{i,i}d_{j,j})^{-1/2}.

The definition of the covariance ignores the links between the neighbor nodes, as the links are often sparse in real applications. For dense graphs, it is straightforward to add the covariance cov(j,j′) in the matrix without significant influence of the computation of the next steps. The variance var(⋅) is a latent variable that will be learned in the training process. Here the correlation function and the learned variance is utilized to compute the covariance between nodes. This will largely decrease the number of the latent variables to be learned. The correlation function cor(i,j) of the nodes will be derived from the topology of the graph, similarly as the GCNN. It can also be defined with other functions, e.g., random-walk graph Laplacian. Note that the Gaussian here defines the probabilistic dependencies between nodes, while the Gaussian in Eq. (5) specifies message distribution of a single node. With Schur complement, it can be easily proven that the covariance matrix defined for the nodes, i and its neighbors, is valid, i.e., the determinant is not zero.

Put everything together, and the conditional variance vâr(i|N(j)) of the node i can be computed as:

vâr(i|N(i))=var(i)−CB⁻¹C^{T}, where

B=diag([var(j₁),var(j₂), . . . ,var(j_{N}_{ᵢ})]) and

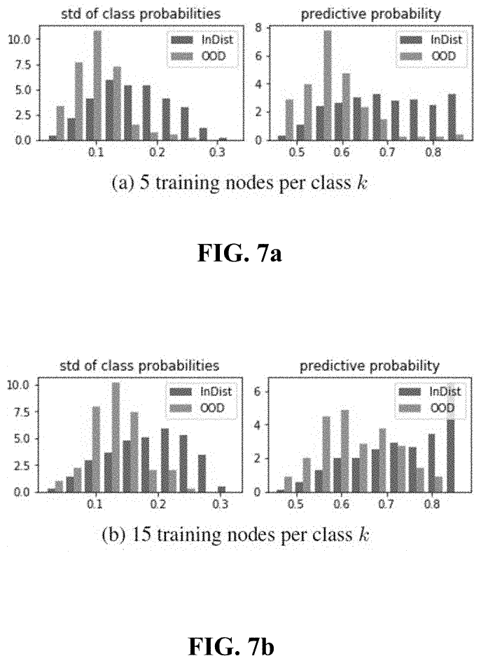

C=[cov(i,j₁),cov(i,j₂), . . . ,cov(i,j_{N}_{ᵢ})], (9)

where B and C are blocks defined in Definition 1. Based on the equation, the exemplary embodiment 40 of FIG. 6 shows that uncertainty 44 can be propagated from the neighbors N(i), 42, to the node i, 46, at each layer [symbol] . Across layers, the variations are transferred with:

[symbol]

(i)=a( [symbol] (i|N(i)) [symbol] (10)

With the uncertainty propagation mechanism of Eq. (9), the more neighbors 42 a node 46 links, the larger the uncertainty 44 is reduced by the available evidence, and thus the smaller the variance of the node is. If a node 46 is isolated from the rest of the graph, then the uncertainty 44 will not be reduced, as no uncertainty reduction can be passed to it.

### Uncertainty Penalized Loss

Embodiments can integrate the learned predictive uncertainty into the loss function to guide the training process. If the prediction of a training example is highly uncertain, then the loss of the single example should be penalized. On the other hand, the training examples in which predictions are certain (i.e. smaller variance), but largely deviate from the ground truth, could be paid more attention in the training process, as optimizing the model to better fit such examples would most likely improve the performance of the model. In particular, loss of each single training example could associate with a factor, which is inversely proportional to the predictive uncertainty of the training example. For continuous configuration variables, the Gaussian likelihood based loss can be used to properly integrate the predictive uncertainty. For example, the loss can be defined as:

$$loss = {( \frac{y - \hat{y}}{\sqrt{2} σ} )}^{2} + ln σ$$

However, the commonly-used loss functions for the categorical configuration variables do not integrate the predictive uncertainty effectively.

For example, the cross entropy loss is computed as:

H(ρ,p)=Σ_{c=1}^{C}ρ(y=c)In p(y=c), (11)

where ρ and p denote the true and predicted probabilities, respectively. Although the uncertainty modeling framework of embodiments of the present disclosure can clearly learn Bayesian confidence of the predicted probability (y), the cross entropy loss still treats each training example equally even if the model specifies that it does not ensure the predictions. Another popular classification loss, expected cross entropy, cannot integrate the predictive uncertainty properly. The loss is generally computed with MC sampling:

$$\begin{matrix}𝔼 [ H ( ρ , p ) ] = \int {\sum }_{c = 1}^{C} ρ ( y = c ) In [ Softmax ( θ ) ] N ( θ ) ] 𝒩 ( θ ; \hat{m} , \hat{\sum } ) \\ \approx \frac{1}{S} {\sum }_{s = 1}^{S} {\sum }_{c = 1}^{C} ρ ( y = c ) In [ Softmax ( {θ}^{( s )} ) ]\end{matrix} , \qquad ( 12 )$$

where θ^{(s)} is the sample message drawn from the learned predictive Gaussian with mean \hat{m} and covariance \hat{Σ}. The loss does not explicitly include predictive uncertainty in the equation. Additionally, the sampling variance of the MC estimator may introduce unexpected randomness and delay the learning process.

The recently introduced classification loss, expected mean squared error (eMSE), is computed as:

eMSE(y,p)= [symbol] ∥y−p∥₂²=∥y− [symbol] [_{P}]∥₂²+var(p) (13)

The eMSE clearly integrates the prediction variance into the loss function Eq. (13). However it does not utilize the variance to penalize the unsure predictions. That means whether the predictions are certain or not, the training process will treat them identically. In addition, uncertainty exists due to the quality and size of the data, as well as the representation capability of the model. Ideally, the model is optimized such that the learned uncertainty approaches the real one. Thus, only minimizing variance of predictive probability may not be enough. Intuitively, this loss would lead the learning process towards parameters that makes the model always report smaller variance, even if the predictions should be unsure due to lack of evidence, e.g., isolated nodes in a graph. Thus the eMSE loss could not work ideally as presumed.

These commonly used classification loss functions show some limitations when integrating predictive uncertainty into the training process. Building on the Gaussian likelihood based loss in the regression problem, embodiments of the present disclosure construct a new loss that can directly use message distributions to explicitly exploit the predictive uncertainty for training. To this end, a Gaussian CDF based loss is introduced for the classification problem. In particular, a training node i is associated with a label y=c_{*} and the message θ=[θ₁, . . . , θ_{C}]. Each dimension θ_{c} is independent of each other, and follows a Gaussian distribution with mean m_{c} and variance σ_{c}². As the label of i is c_{*}:

τ_{c}=θ_{c}−θ_{c}_{_{*}}<0,c≠c_{*}. (14)

The vector τ=[τ₁, . . . , τ_{C}]_{c=1,c≠c*}^{C} follows a (C−1)-dimensional Gaussian with mean μ and covariance Λ as:

$$μ = [ {m}_{1} - {m}_{{c}_{*}} , … , {m}_{C} - {m}_{{c}_{*}} ] \\ Λ = [ \begin{matrix}{σ}_{1}^{2} + {σ}_{{c}_{*}}^{2} & {σ}_{{c}_{*}}^{2} & … & σ \frac{2}{{c}_{*}} \\ {σ}_{{c}_{*}}^{2} & {σ}_{{c}_{*}}^{2} & … & {σ}_{C}^{2} + {σ}_{{c}_{*}}^{2} \\ {σ}_{{c}_{*}}^{2} & {σ}_{{c}_{*}}^{2} & … & {σ}_{C}^{2} + {σ}_{{c}_{*}}^{2}\end{matrix} ]$$

where diagonal elements of the covariance matrix are σ_{c}²+σ_{c}_{_{*}}², and non-diagonal elements are σ_{c}_{_{*}}². Note that the covariance matrix is full, and the size is (C−1)×(C−1). Given the multivariable Gaussian, the loss of the training example i based on the Gaussian likelihood probability (not the density function used for the regression problem) can now be computed:

[symbol]

=p(y=c_{*}|μ,Λ)=∫_{-∞}⁰ [symbol] _{C-1}(τ;μ,Λ)dτ (16)

Note that Eq. (16) allows for computation of the likelihood of the discrete label with an improper integral of a Gaussian, which avoids the expensive marginalization with unconjugated softmax functions. The improper integral of Eq. (16) is not analytically tractable. The standard MC sampling does not work well due to the correlation of the dimensions and the limit of the integration. To get the integral, a quasi MC approximation based on Genz, A., Numerical computation of multivariate normal probabilities (1992), in Journal of Computational and Graphical Statistics 1(2): 141-49, which is hereby incorporated by reference herein, is used, which can largely reduce the variance caused by an MC estimator. First, the variable τ is converted to ξ with Cholesky decomposition Λ=LL^{T} such that the distribution of ξ is a standard C−1 dimensional Gaussian:

ξ=L⁻¹(τ−μ)˜ [symbol] _{C-1}(0,1)

Though ξ_{c} is independent of each other, the multi-dimensional improper integral of Eq. (16) cannot be computed in a dimension independent manner, since the integration upper bound of a dimension c is conditioned on the dimensions c′<c before it. In particular, the Gaussian likelihood of Eq. (16) is computed as [symbol] ∝:

$${\int }_{- ∞}^{{b}_{1}} exp ( - \frac{{ξ}_{1}^{2}}{2} ) … {\int }_{- ∞}^{{b}_{C - 1}} exp ( - \frac{{ξ}_{C - 1}^{2}}{2} ) d {ξ}_{1} … d {ξ}_{C - 1} \qquad ( 18 )$$

where the upper bound of the integration is:

$${b}_{c} = \frac{- {μ}_{c} - {\sum }_{{c}^{′} = 1}^{c - 1} {ℓ}_{c , {c}^{′}} {ξ}_{{c}^{′}}}{{ℓ}_{c , c}} \qquad ( 19 )$$

[symbol]

_{c,c′} denotes the entry of the lower triangular matrix L from Cholesky decomposition of Λ. Since the lower bound of the integration is negative infinity, variance of a standard MC estimator will be large. Thus the variable ξ is further transferred such that the integration has a finite limit (0, 1):

$${ξ}_{c} = {Φ}^{- 1} ( {a}_{c} {ζ}_{c} ) , where \\ Φ ( x ) = \frac{1}{\sqrt{2 π}} {\int }_{- ∞}^{x} exp ( - \frac{{t}^{2}}{2} ) dt , and \\ {a}_{c} = Φ ( \frac{- {μ}_{c}}{{ℓ}_{c , c}} - {\sum }_{{c}^{′} = 1}^{c - 1} \frac{{ℓ}_{c , {c}^{′}}}{{ℓ}_{c , c}} {Φ}^{- 1} ( \begin{matrix}{a}_{{c}^{′}} & {ζ}_{{C}^{′}}\end{matrix} ) ) \qquad ( 20 )$$

The likelihood [symbol] in Eq. (18) is as follows:

[symbol]

=∫₀¹∫₀¹ . . . ∫₀¹a₁a₂ . . . a_{C-1}dζ₁ . . . dζ_{C-2} (21)

Note that the integral of Eq. (21) is C−2 dimensional, since the computation of a_{c} does not depend on ζ_{C-1} and it can thus be directly marginalized out. Given the finite limit (0, 1), lattice rules, such as a Halton sequence, can be used instead of a crude sampling strategy to construct the MC estimator. Putting everything together, the likelihood of the discrete class label of the node i is formulated as:

$$ℒ = \frac{1}{S} {\sum }_{s = 1}^{S} {a}_{1} {a}_{2}^{( s )} … {a}_{C - 1}^{( s )} \qquad ( 22 )$$

where a_{c}^{(s)} is computed with Eq. (20) using ζ^{(s)} sampled from a (C−2)-dimensional Halton sequence. a₁=Φ(−μ₁/ [symbol] 1,1) is a constant. The proposed loss explicitly integrates predictive uncertainty (variance of message) in the learning process.

Considering computational efficiency in practice, the loss can be approximated by skipping the off-diagonal entries of the covariance matrix A, then the likelihood of Eq. (22) can be simplified as:

$$ℒ = {\prod }_{c = 1}^{C - 1} Φ ( \frac{- {μ}_{c}}{\sqrt{{σ}_{c}^{2} + {σ}_{{c}_{*}}^{2}}} ) = {\prod }_{c = 1}^{C - 1} \frac{1}{2} [ 1 + erf ( \frac{{m}_{{c}_{*}} - {m}_{c}}{\sqrt{2 ( {σ}_{c}^{2} + {σ}_{{c}_{*}}^{2} )}} ) ]$$

where erf(⋅) denotes the error function. The simplified likelihood of Eq. (23) clearly incorporates variance of message and difference of message expectations. The larger the learned mean m_{c} at the given label c_{*} is than the other dimensions m_{c}, the more likely the model makes correct predictions. If the model is not sure about the prediction, i.e. a larger σ_{c} or σ_{c}_{_{*}}, then the difference m_{c}_{_{*}}−m_{c} is penalized. The likelihood is reduced accordingly.

### Empirical Analysis

Evaluating quality of uncertainty estimation is a challenging task due to the unavailable ground truth of the real uncertainty. To measure the performance of the embodiments' uncertainty estimation, a set of experiments were conducted to explore the following questions:
Q1: do embodiments of the present disclosure provide more reliable predictions in the normal settings?
Q2: for the OOD nodes, do the prediction results of the embodiments report their uncertainty properly?
Q3: how does the graph structure influence the uncertainty of the predictions? Can embodiments capture the influence correctly?

Datasets: the popular benchmark datasets cora and citeseer (see Elinas et al. (2020); and Kipf and Welling (2016)) are used for the empirical analysis, where the nodes are documents, and features are bag-of-words (BOW) of the documents. The links are defined by the citation relations between the documents. An undirected graph is constructed according to the citation links, which leads to a symmetric binary adjacency matrix. The label of each node specifies the class of the document. Each document belongs to a single class. The learning task is to predict unknown labels for the nodes.

Baselines: embodiments are compared with the recent works, including: GCNN, see Kipf and Welling (2016), graph attention network (GAT), and variational graph convolutional networks (VGCN), see Elinas et al. (2020). The VGCN is a Bayesian NN assuming a prior distribution over graphs. For these base-line methods, the optimal parameter settings and network architecture provided by the authors are used. The details can be found on GitHub repositories of GCNN (<<github.com/topics/gcnn>>), GAT (<<github.com/topics/gat>>), and VGCN (<<github.com/ebonilla/VGCN>>).

Metrics: three measurements to quantify the performance of the embodiments are considered. Besides the commonly used predictive accuracy (ACC), average calibration error (ACE) and expected calibration error (ECE) [9, 26] are selected to measure reliability of the embodiments' confidence in their predictions, i.e., calibration. See Guo et al. (2017); and Neumann, L. et al., Relaxed softmax: Efficient confidence auto-calibration for safe pedestrian detection (2018), in NIPS Workshop on Machine Learning for Intelligent Transportation Systems, which is hereby incorporated by reference herein. In the classification task, a model can be reliable if the predictive probability \hat{p} is always the true probability p. Technically, ACE and ECE are defined as follows to quantify the reliability:

$$ACE = \frac{1}{{B}_{+}} {\sum }_{b = 1}^{B} \vert {ACC}_{b} - {\hat{p}}_{b} \vert \\ ECE = {\sum }_{b = 1}^{B} \frac{{n}_{b}}{N} \vert {ACC}_{b} - {\hat{p}}_{b} \vert$$

Both ACE and ECE split the probabilistic interval into a B number of bins. For each bin, obtain averaged accuracy ACC_{b} and averaged predictive probability \hat{P}_{b}. ECE is an expected difference between ACC_{b} and \hat{P}_{b}, while ACE is an average, i.e. the weight of each bin in Eq. (24) is defined differently. B₊ denotes the number of nonempty bins. The smaller the scores are, the more reliable the method is. That means the predictions are more likely to match the true probability (confidence).

Q1: do embodiments of the present disclosure provide more reliable predictions in the normal settings?

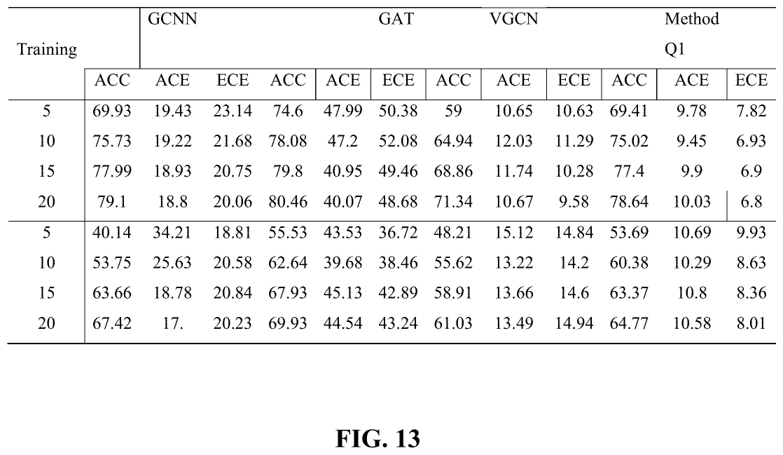

Here a normal setting is assumed, i.e., all classes {1, . . . ,K} are observed in the training data, and there are no OOD examples in the test data. To obtain a comprehensive evaluation, different sizes of training data are set, e.g., roughly 1%, 2%, 3% and 4% of nodes as training. In particular, for each data set, 5, 10, 15, 20 nodes per class are randomly selected for training, 200 nodes are randomly selected for validation, and 2000 nodes are randomly selected for test. The experiments are repeated 10 times, and report the averaged results over all reruns. FIG. 13 summarizes the results. The embodiments reach comparable results to state-of-the-art methods in terms of prediction accuracy, but achieve superior performance in terms of reliability (ACE and ECE). GAT reports the highest accuracy, however its reliability is significantly worse than the other methods. The deeper network architecture, e.g., multi-head self-attentional layer, indeed improves the accuracy, but largely reduces reliability of the results as a serious cost. VGCN, as a Bayesian generative neural network, also reports good reliability, although it is still worse than embodiments of the present disclosure. The experiments reveal that, in the normal setting, embodiments of the present disclosure provide the most reliable predictions with comparable accuracy at all situations. Learning the uncertainty of the passed messages is an effective way to model predictive uncertainty.

FIG. 13: Predictive performance of the methods in the normal setting. The metric ACC measures prediction accuracy (the higher the better), while ACE and ECE quantify the reliability of the predictions (the smaller the better).

Q2: for the OOD nodes, do the prediction results of the embodiments report their uncertainty properly?

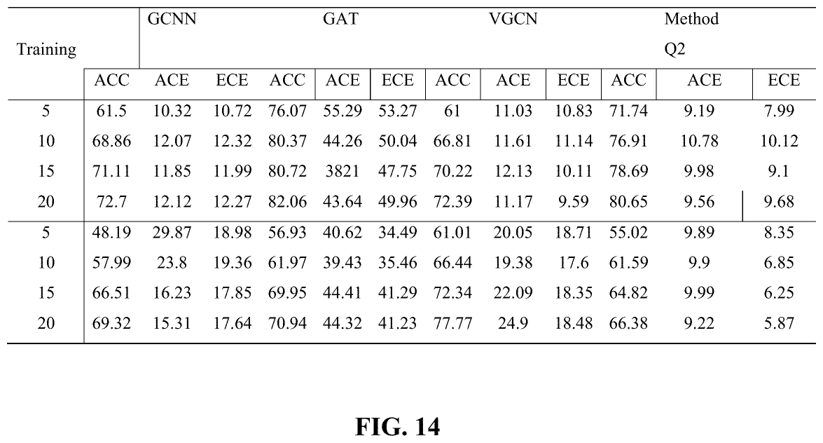

In the real applications, the OOD setting often happens. In a typical case, the test examples belong to a class that is not observed in the training data, and thus this unknown class of test examples are out-of-distribution. For the graph data, the OOD examples are created in the following way. The nodes of the class K are removed from the training and validation, and the model is trained with the examples from the rest classes {1, . . . , K−1}. Here the node is denoted with a label yᵢ∈{1, . . . , K−1} as an InDist example, and with yᵢ=K as an OOD one. For the InDist examples, the predictive performances are reported in FIG. 14. All the results are averages over 10 reruns. Similarly as the above experiments, embodiments of the present disclosure outperform the baselines in terms of reliability. Since the training process of embodiments of the present disclosure consider the uncertainty of the messages, and penalize the training examples with uncertain predictions, embodiments are led to address the more complicated OOD setting with better reliability and good accuracy, compared with the baselines.

FIG. 14: Predictive performance of the methods for the InDist nodes in the OOD setting. The metric ACC measures prediction accuracy (the higher the better), while ACE and ECE quantify the reliability of the predictions (the smaller the better).

Furthermore, embodiments provided an in-depth analysis of the OOD predictions. The experiments are designed as follows. Given a test node j, the probability pⱼ is K−1 dimensional, where p_{j,k} denote the probability of the node j belonging to the class k. The node j is assigned to the class k*, if p_{j,k*}>p_{j,k}, for any k∈{1, . . . , K−1} and k≠k *. The std of pⱼ is computed as

$$\sqrt{\frac{1}{K - 1}} {\sum }_{k = 1}^{K - 1} {( {p}_{j , k} - \frac{1}{K - 1} {\sum }_{k = 1}^{K - 1} {p}_{j , k} )}^{2} .$$

A smaller std means the predictive probabilities are equally distributed over all possible dimensions (i.e. classes), which implies the embodiments are actually not sure which class the test node should belong to. In contrast, a larger std specifies probability mass is concentrated, and embodiments are more confident of the prediction. The maximum probability p_{j,k*} of the node j also implies confidence. The larger the probability is, the more confident the embodiments are of the prediction. p_{j,k*} and std of pⱼ averaged over all nodes j are reported for InDist and OOD ones, shown in Table 2. Embodiments report significantly larger p_{j,k*} for the InDist test nodes, compared with the OOD ones. The std of pⱼ is much larger for the InDist than for the OOD. These results demonstrate that the embodiments are more confident of the InDist predictions than the OOD ones, and does capture the uncertainty of the OOD nodes. FIGS. 7a-7d illustrate the distributions of p_{j,k*} for the InDist nodes and the OOD ones. In each of FIGS. 7a-7d, the left panel is histogram of the std of pⱼ, where the x-axis denotes the std and the y-axis is its density, and the FIGS. are separated based on the number of nodes perk selected from each class as training data. The right panel is histogram of the predictive probability p_{j,k*}, where x-axis is p_{j,k*}, and the y-axis is the density. FIGS. 7a-7d also provide an analysis of the inferred predictive probabilities in the OOD setting: distributions of the probabilities pj,* for InDist nodes with OOD. The difference is significant, which further visualizes that embodiments of the present disclosure model the uncertainty of the predictions well.

TABLE 2
Analysis of the inferred predictive probabilities in the OOD setting:
compare in-distribution (InDist) nodes with out-of-distribution
(OOD) ones.

| | p_{j,k}* | | Std of pj | |
|---|---|---|---|---|
| Training | InDist | OOD | InDist | ODD |
| 5 | 0.70 | 0.56 | 0.16 | 0.10 |
| 10 | 0.70 | 0.59 | 0.15 | 0.10 |
| 15 | 0.75 | 0.62 | 0.19 | 0.13 |
| 20 | 0.74 | 0.60 | 0.19 | 0.11 |

Q3: how does the graph structure influence the uncertainty of the predictions? Can embodiments capture the influence correctly?

Since there is no ground truth about uncertainty, the experiment is designed to further validate that embodiments learn the predictive uncertainty appropriately, such that it can capture the relations between the graph structure and the predictive uncertainty. In particular, if a node is connected with multiple neighbors, i.e. a higher node degree, then the predictive uncertainty would be more likely smaller, as more evidence will flow to the node through its neighbors for class prediction. Moreover, if a node is far from the training nodes, then the evidence can vanish during propagation, and thus the uncertainty of the prediction could be higher. Experiments were conducted to demonstrate if the learned uncertainty matches the intuitions. To quantify the position of a node in the graph topology, two criteria were considered: node degree and length of shortest path between the node and the training ones. To quantify the uncertainty, the learned variances of the message distribution were used. Technically, two scores were selected, the averaged std and the entropy of the multidimensional Gaussian of the messages.

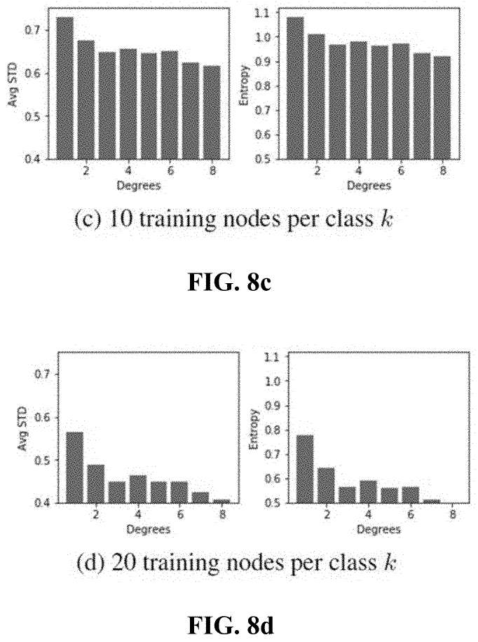

FIGS. 8a-d illustrate that the predictive uncertainty decreases with the increase of the node degree. FIGS. 8a-d also provide an analysis of the learned predictive uncertainty and influence of the node degree on the uncertainty (measured with the averaged std and the entropy of the message distribution). FIGS. 9a-d show that the predictive uncertainty does increase with the averaged shortest path length from the test node to the training nodes. FIGS. 9a-d also provide an analysis of the learned predictive uncertainty and influence of the averaged shortest path length from the test node to the training nodes on the uncertainty (measured with the averaged std and the entropy of the message distribution). These results reveal that embodiments of the present disclosure capture the relations between predictive uncertainty and graph structure, which demonstrates the predictive uncertainty is learned properly.

Embodiments of the present disclosure provide a novel GNN method based on Bayesian confidence of predictive probability to explicitly quantify uncertainty in node classification. Beyond the deterministic process of normal GNNs, the embodiments model the uncertainty of the node messages, and propagate the uncertainty together with the messages over the entire graph, by which the distribution of the predictive probability can be learned, and thus leads to a clear measurement of the uncertainty. Furthermore, embodiments present a novel loss that clearly integrates the predictive uncertainty into the training process, such that the training examples are penalized to contribute less to the loss if the model reports high uncertainty on the predictions. A variety of experiments were conducted to analyze the performance of the embodiments. The extensive empirical analysis demonstrates that embodiments of the present disclosure learn the predictive uncertainty effectively.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for providing a trustworthy artificial intelligence (AI) graph-based solution for configuring a plurality of systems in a network, the method comprising:
generating a graph in which each node in the graph represents one of the plurality of systems, wherein links are created between the nodes in the graph;
passing messages along the links, wherein each node:
passes a message and a level of uncertainty in the message to neighboring nodes of each node, and
receives subsequent messages and subsequent levels of uncertainty in the subsequent messages back from the neighboring nodes,
updating, by each node based on the subsequent messages and the subsequent levels of uncertainty in the subsequent messages that were received from the neighboring nodes, the respective message and the respective level of uncertainty in the respective message; and
predicting configuration values for the systems based on the updated messages and the updated levels of uncertainty.

2. The method of claim 1, wherein passing the messages along the links comprises:
propagating the level of uncertainty in the message through the graph from each node to the neighboring nodes of each node; and
accounting for the level of uncertainty in the message in each subsequent level of uncertainty in the subsequent message that is passed by the neighboring node of each node which received the level of uncertainty in the message from the node.

3. The method of claim 2, wherein accounting for the level of uncertainty in the message further comprises:
assigning a respective weight to each link;
predicting the levels of uncertainty in the message propagated along each link; and
adjusting the weight of each link based on values of the predicted levels of uncertainty in the messages propagated along the links.

4. The method of claim 1, the method further comprising respectively assigning a weight to each of the links and iterating a weight matrix of the graph using the levels of uncertainty in the messages.

5. The method of claim 4, the method further comprising:
using the level of uncertainty in the message to calculate a loss term; and
integrating the loss term into the iteration of the weight matrix of the graph.

6. The method of claim 1, wherein a first node of the nodes models a first distributed unit of an open radio access network, and one of the neighboring nodes, which is a neighbor node of the first node, models a second distributed unit of the open radio access network, and at least one of the links is created based on a similarity of a physical relationship of a first respective radio unit with the first distributed unit and a physical relationship of a second respective radio unit with the second distributed unit.

7. The method of claim 6, wherein each of the messages communicate a resource demand of a respective distributed unit in the graph, and predicting configuration values for the systems comprises determining an allocation of a resource of the resource demand across the distributed units in the graph.

8. The method of claim 1, wherein passing messages along the links comprises:
passing, by one of the nodes, the message and the level of uncertainty in the message to at least a first neighboring node which neighbors the node;
passing, by a second neighboring node which neighbors the first neighboring node, a message of the second neighboring node and a level of uncertainty in the message of the second neighboring node to at least the first neighboring node;
producing an updated message of the first neighboring node that is a weighted sum of the message of the node and the message of the second neighboring node;
producing an updated level of uncertainty in the message of the first neighboring node based on the previous level of uncertainty in the message of the node and the level of uncertainty in the message of the second neighboring node to reduce the level of uncertainty of the updated level of uncertainty in the message of the first neighboring node; and
passing the updated message and an updated level of uncertainty in the updated message to one of the neighboring nodes of the first neighboring node using the links.

9. The method of claim 1, wherein the updated level of uncertainty in each node's message is reduced with respect to the level of uncertainty in the message proportionally to the number of neighboring nodes to each respective node.

10. The method of claim 1, wherein predicting configuration values further comprises predicting confidence intervals of the predicted configuration values for the systems.

11. The method of claim 1, wherein updating each node's message and the level of uncertainty in each node's message further comprises using a Gaussian function learned with a local topology of the links.

12. The method of claim 11, wherein the Gaussian function for each node is conditioned on the degree of the node.

13. The method of claim 1, further comprising adapting a configuration of at least one of the systems based on the predicted configuration values for the systems.

14. A system comprising one or more hardware processors which, alone or in combination, are configured to provide for execution of the following steps:
generating a graph in which each node in the graph represents one of a plurality of systems, wherein links are created between the nodes in the graph;
passing messages along the links, wherein each node:
passes a message and a level of uncertainty in the message to neighboring nodes of each node; and
receives subsequent messages and subsequent levels of uncertainty in the subsequent messages back from the neighboring nodes,
updating, by each node based on the subsequent messages and the subsequent levels of uncertainty in the subsequent messages that were received from the neighboring nodes, the respective message and the respective level of uncertainty in the respective message; and
predicting configuration values for the systems based on the updated messages and the updated levels of uncertainty.

15. A tangible, non-transitory computer-readable medium having instructions thereon which, upon being executed by one or more hardware processors, alone or in combination, provide for execution of the following steps:
generating a graph in which each node in the graph represents one of a plurality of systems, wherein links are created between the nodes in the graph;
passing messages along the links, wherein each node:
passes a message and a level of uncertainty in the message to neighboring nodes of each node; and
receives subsequent messages and subsequent levels of uncertainty in the subsequent messages back from the neighboring nodes,
updating, by each node based on the subsequent messages and the subsequent levels of uncertainty in the subsequent messages that were received from the neighboring nodes, the respective message and the respective level of uncertainty in the respective message; and
predicting configuration values for the systems based on the updated messages and the updated levels of uncertainty.
